(19) United States
(12) Patent Application Publication
(10) Pub. No.: US 2010/0158222 A1
(43) Pub. Date: Jun. 24, 2010

(54) INFORMATION PROCESSING APPARATUS, OUTPUT METHOD AND RECORDING MEDIUM

(75) Inventor: Masahiko Murakami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/630,233

(22) Filed: Dec. 3, 2009

(30) Foreign Application Priority Data
Dec. 24, 2008 (JP) 2008-328122

(51) Int. Cl. H04M 11/00

(52) U.S. Cl. 379/93.17; 379/142.06

(57) ABSTRACT

An information processing apparatus which outputs information includes an acquisition unit that acquires identification information for identifying an intended party, a storage unit that stores, when identification information is acquired, a file operation record indicating a file operated during a call in a storage unit so that the file operation record is associated with the identification information, and an output unit that outputs, in a case of determining that identification information that matches identification information stored in the storage unit is acquired by the acquisition unit, information about the file stored in the storage unit in association with the acquired identification information.

### CROSS-REFERENCE TO RELATED APPLICATIONS

This application is based upon and claims the benefit of priority of the prior Japanese Patent Application No. 2008-328122, filed on Dec. 24, 2008, the entire contents of which are incorporated herein by reference.

### FIELD

An embodiment relates to a recording medium having a program recorded thereon, an information processing apparatus, an output method, and recording medium storing a program for causing a computer to output information.

### BACKGROUND

The computerization of various documents and integration of information have become more common in recent years. Users store computerized information in storage devices in computers or server computers. The users further classify the stored information into a plurality of folders to facilitate retrieval of the information (see, for example, Japanese Patent Application Laid-open Publication No. 2004-56518).

### SUMMARY

According to an aspect of the invention, an information processing apparatus which outputs information includes an acquisition unit that acquires identification information for identifying an intended party; a storage unit that stores, when identification information is acquired by the acquisition unit, a file operation record indicating a file operated during a call in a storage unit so that the file operation record is associated with the identification information; and an output unit that outputs, in a case where it is determined that identification information that matches identification information stored in the storage unit is acquired by the acquisition unit, information about the file stored in the storage unit in association with the acquired identification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an overview of an output system.

FIG. 2 is a block diagram of hardware of a terminal server.

FIG. 3 is a block diagram of hardware of a computer.

FIG. 4 illustrates a record layout of a call record DB.

FIG. 5 illustrates a record layout of a user DB.

FIG. 6 illustrates a record layout of an operation record file.

FIG. 7 illustrates an image of a guide screen.

FIG. 8 illustrates a processing for acquiring an intended party number.

FIG. 9 illustrates a processing for storing a file operation record.

FIG. 10 illustrates a processing for storing a file operation record.

FIG. 11 illustrates a processing for storing a file operation record.

FIG. 12 illustrates a processing for displaying, during a call, information about a file relating to a previous call.

FIG. 13 is illustrates a processing for displaying, during a call, information about a file relating to a previous call.

FIG. 14 illustrates a processing for displaying, during a call, information about a file relating to a previous call.

FIG. 15 illustrates a processing for displaying, during a call, information about a file relating to a previous call.

FIG. 16 illustrates an overview of an output system according to an embodiment.

FIG. 17 is a block diagram of hardware of a computer according to an embodiment.

FIG. 18 illustrates a record layout of a call record DB.

FIG. 19 illustrates a record layout of an operation record file according to an second embodiment.

FIG. 20 illustrates an image of a guide screen according to an embodiment.

FIG. 21 illustrates a processing for storing an operation record.

FIG. 22 illustrates a processing for storing an operation record.

FIG. 23 illustrates a processing for displaying.

FIG. 24 illustrates a processing for displaying.

FIG. 25 illustrates a record layout of an operation record file.

FIG. 26 illustrates an image of a setting screen.

FIG. 27 illustrates a displayed image including links displayed during a call.

FIG. 28 illustrates a processing for displaying according to an embodiment.

FIG. 29 illustrates a processing for displaying according to an embodiment.

FIG. 30 illustrates a displayed image including links.

FIG. 31 illustrates a processing for displaying.

FIG. 32 illustrates a record layout of an operation record file according to an embodiment.

FIG. 33 illustrates a displayed image including links.

FIG. 34 illustrates a processing for displaying according to an embodiment.

FIG. 35 illustrates an overview of a display system according to an embodiment.

FIG. 36 is a block diagram of hardware of a computer.

FIG. 37 illustrates an overview of a display system according to an embodiment.

FIG. 38 is a block diagram of hardware of a computer according to an embodiment.

FIG. 39 is a block diagram of hardware of a mobile telephone.

FIG. 40 is a block diagram of hardware of a computer according to an embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Typically, for example, an inquiry about information regarding a specific business during a call would make a person to act in haste to retrieve a document regarding the business or a file regarding the business using a computer.

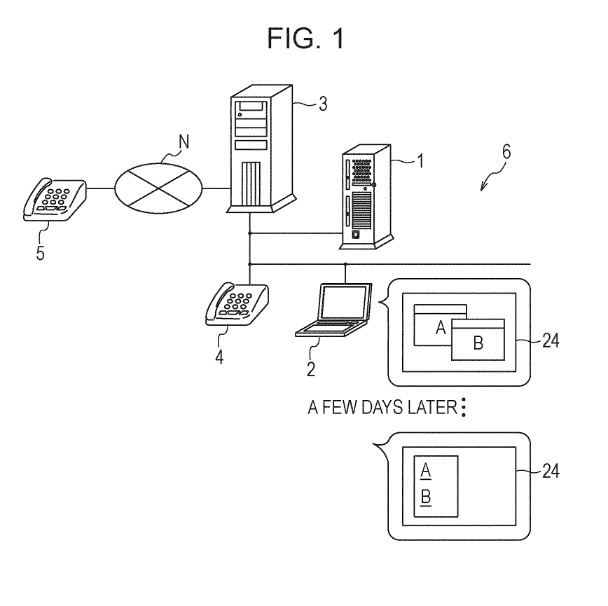

FIG. 1 illustrates an overview of an output system. The output system includes an information processing apparatus 1, a computer 2, a control server computer 3, and telephones 4 and 5. The telephones 4 and 5 are, for example, Internet Protocol (IP) telephone terminals, and are capable of making a call via the Voice over Internet Protocol (VoIP) over a communication network N including the Internet and a public telephone network and a local area network (LAN) 6. The telephones 4 and 5 are hereinafter referred to as “IP telephone terminals 4 and 5”.

The control server computer 3 may be an apparatus serving as a relay between the public telephone network and an IP-telephone-based extension line network and having circuit switching capabilities for establishing a connection with the IP telephone terminal 4. The control server computer 3 is, for example, an Internet Protocol-Private Branch Exchange (IP-PBX) or an x Digital Subscriber Line (xDSM) modem. The control server computer 3, the information processing apparatus 1, the IP telephone terminal 4, and the computer 2 are connected to one another via the LAN 6 to transmit and receive speech data, various file data, and any other data. The information processing apparatus 1 is, for example, a terminal server computer, a Post Office Protocol (POP) server computer, a proxy server computer, or the like. The information processing apparatus 1 executes various processes in accordance with requests received from the computer 2.

The information processing apparatus 1 further receives information for identifying the intended party and the call origin party, which is output from the control server computer 3, and executes processes described below according to an embodiment. In the following description, by way of example, the information processing apparatus 1 is a terminal server computer configured to execute various applications in accordance with requests received from the computer 2 and to output execution results to the computer 2. In the following description, the information processing apparatus 1 is referred to as a “terminal server 1”. The control server computer 3 is, for example, an IP-PBX 3.

Furthermore, in an embodiment, by way of example, the hardware of the IP-PBX 3 is separately provided. In another embodiment, however, the IP-PBX 3 and the terminal server 1 may be integrated into a single unit including by installing a program to be executed by the IP-PBX 3 into the terminal server 1 and implementing the IP-PBX function by the terminal server 1. In an embodiment, furthermore, by way of example, the IP telephone terminal 4 that is based on VoIP is used. However, other examples may be used. For example, the telephones 5 and 4 may be telephones that are based on a public line network or a mobile telephone network. In this case, the control server computer 3 implements Parlay or the like as an application programming interface (API), and outputs identification information about the telephone 5 at the transmission destination to the terminal server 1.

An overview of an embodiment will now be described. It is assumed that the user of the IP telephone terminal 5 makes a call to the user of the IP telephone terminal 4 and that, a few days later, the user of the IP telephone terminal 5 also makes a call to the user of the IP telephone terminal 4. That is, there exists a prior exchange of a call between terminal 4 and terminal 5. In accordance with an inquiry from the user of the IP telephone terminal 5, the user of the IP telephone terminal 4 operates the computer 2 and opens a file regarding, for example, a word processor from the terminal server 1. As illustrated in FIG. 1, files A and B are displayed on a display unit 24 of the computer 2. In this case, the IP-PBX 3 outputs identification information about the IP telephone terminal 5 for specifying the intended party and the call origin party to the terminal server 1. Examples of the identification information for specifying the intended party and the like include the telephone number of the IP telephone terminal 5, the physical address unique to the IP telephone terminal 5, such as the media access control (MAC) address, the IP address, and the ID of the user who uses the IP telephone terminal 5. In the following description, the identification information is a telephone number. However, the present invention is not limited to any particular identification information and may utilize any information uniquely identifying a source including that of a call data associated with a user making the call or associated with a device from which the call is made.

The terminal server 1 acquires the telephone number of the intended party and stores the acquired telephone number, the call start time, and the call end time. The terminal server 1 stores records of various files operated (hereinafter referred to as “file operation records” or “operation records”) using the computer 2 for the period from the call start time to the call end time so that the file operation records are associated with the acquired telephone number. In the above example, information indicating that the files A and B are opened across the display unit 24 is stored.

A few days later, the user of the IP telephone terminal 5 also makes a call to the user of the IP telephone terminal 4, and the terminal server 1 again acquires the telephone number of the IP telephone terminal 5 from the IP-PBX 3. In this case, the file operation records stored in association with the acquired telephone number are read. In the above example, the terminal server 1 reads the records of the files A and B operated using the computer 2. The terminal server 1 outputs the read information about the files A and B to the computer 2. The computer 2 displays the information about the files A and B on the display unit 24. For example, as illustrated in FIG. 1, links for accessing the files A and B are displayed.

Therefore, by clicking on the link to access the file A or B from the computer 2, the user of the IP telephone terminal 4 can appropriately answer the telephone from the user of the IP telephone terminal 5 without searching through paper materials during the telephone or without searching for the file during the telephone. In an embodiment, a call is made from the IP telephone terminal 5 to the IP telephone terminal 4, by way of example. However, other examples may be used. In an example, conversely, the IP telephone terminal 4 may make a call to the IP telephone terminal 5. Also in this case, the IP-PBX 3 outputs the telephone number of the intended party, namely, the IP telephone terminal 5, to the terminal server 1.

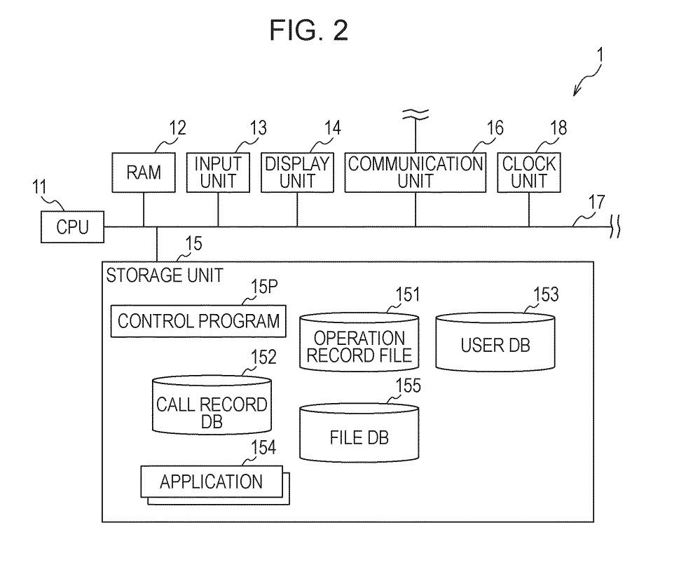

Detailed processes will now be described. FIG. 2 is a block diagram of the hardware of the terminal server 1. The terminal server 1 includes a central processing unit (CPU) 11 serving as a control unit, a random access memory (RAM) 12, an input unit 13, a display unit 14, a communication unit 16, a clock unit 18, a storage unit 15, and any other suitable unit. The CPU 11 is connected to the hardware units of the terminal server 1 via a bus 17, and controls them. The CPU 11 further implements various software functions in accordance with a control program 15P stored in the storage unit 15. The display unit 14 is, for example, a liquid crystal display, an organic electro-luminescent (EL) display, or the like. The display unit 14 displays information in accordance with an instruction of the CPU 11. The input unit 13 includes, for example, a keyboard and a mouse. Operation information input from the input unit 13 is output to the CPU 11.

The communication unit 16 serving as an acquisition unit is, for example, a gateway functioning as a firewall, or a LAN card. The communication unit 16 serving as an acquisition unit transmits and receives information to and from the IP-PBX 3, the computer 2, and the like via the Hypertext Transfer Protocol (HTTP) or the like. Further, when the IP-PBX 3 outputs the telephone number of the intended party (hereinafter referred to as an “intended party number”), namely, the IP telephone terminal 5, and the telephone number of the call origin party (hereinafter referred to as a “call origin party number”), namely, the IP telephone terminal 4, to the terminal server 1, the communication unit 16 receives the intended party number and the call origin party number. When the IP-PBX 3 outputs information indicating that the call has been disconnected (hereinafter referred to as “disconnection information”) to the terminal server 1, the communication unit 16 receives the disconnection information. The communication unit 16 outputs the received intended party number, call origin party number, and disconnection information to the CPU 11. The clock unit 18 outputs date and time information to the CPU 11.

The storage unit 15, such as a hard disk, stores the control program 15P, a call record database (DB) 152, an application 154, an operation record file 151, a user DB 153, a file DB 155, and the like. Those files and DBs are described below.

In an embodiment, by way of example, the file DB 155 and the like are stored in the storage unit 15 of the terminal server 1. However, other examples may be used. For example, a database server or the like may be connected to the LAN 6 via the communication unit 16, and the file DB 155 and the like may be stored in the database server so that information can be read or written as necessary. In this case, the CPU 11 executes necessary processes such as storing and retrieving information through interactions using the Structured Query Language (SQL) or the like in a schema with which the keys of the fields in each DB are associated.

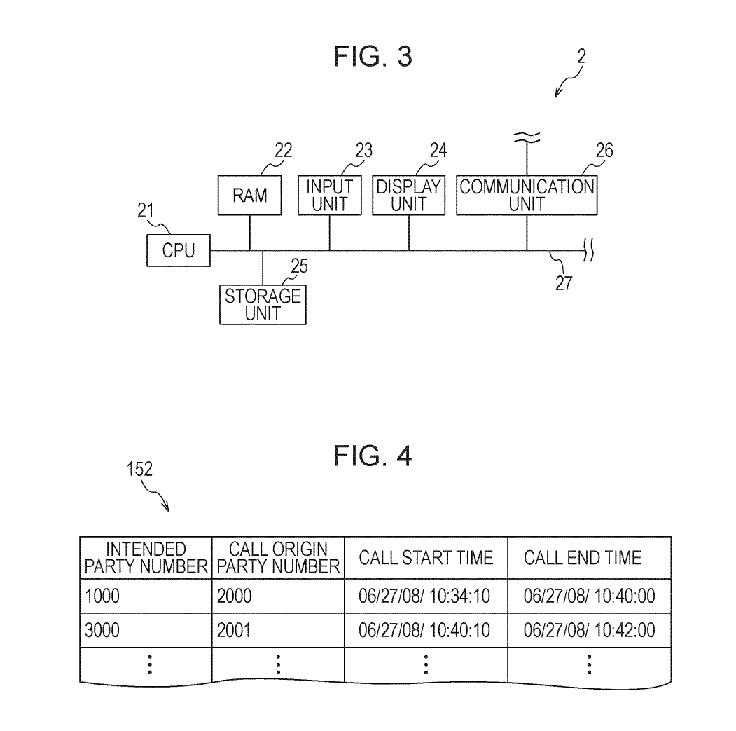

FIG. 3 is a block diagram of the hardware of the computer 2. The computer 2 includes a CPU 21, a RAM 22, an input unit 23, a display unit 24, a communication unit 26, a storage unit 25, and any other suitable unit that is usable to implement operation(s) described herein. The computer 2 is, for example, a personal computer. The computer 2 causes the terminal server 1 to execute the applications 154 and store files. The CPU 21 is connected to the hardware units of the computer 2 via a bus 27, and controls the hardware units. The display unit 24 is, for example, a liquid crystal display, an organic EL display, or the like. The display unit 24 displays the information output from the terminal server 1, such as a file, in accordance with an instruction of the CPU 21.

The input unit 23 includes a keyboard, a mouse, and any other suitable device. Operation information input from the input unit 23 is output to the CPU 21 and the terminal server 1. The communication unit 26 is, for example, a LAN card or the like. The communication unit 26 transmits and receives information to and from the terminal server 1 via the remote desktop protocol or the like. The storage unit 25 is, for example, a hard disk or a large capacity memory. The storage unit 25 stores information in accordance with an instruction of the CPU 21. In an embodiment, for simplicity of description, a single computer 2 is connected to the LAN 6 by way of example. However, a plurality of computers 2 may be connected in a similar manner.

FIG. 4 illustrates a record layout of the call record DB 152. The call record DB 152 includes an intended party number field, a call origin party number field, a call start time field, and a call end time field. The intended party number field stores, for example, intended party number “1000”, which is the telephone number of the IP telephone terminal 5. The call origin party number field stores call origin party number “2000”, which is a telephone number of the call origin party. The call start time field stores the date and time when a call is initiated in association with the intended party number and the call origin party number. Likewise, the call end time field stores the date and time when the call is terminated in association with the intended party number and the call origin party number.

When a communication is established between the IP telephone terminals 5 and 4, the IP-PBX 3 outputs the intended party number, which is the telephone number of the calling party, namely, the IP telephone terminal 5, and the call origin party number, which is the telephone number of the IP telephone terminal 4, to the terminal server 1. The output of the intended party number to the terminal server 1 serves as information indicating the initiation of a call. The intended party number, which is the telephone number of the IP telephone terminal 5, is also output to the IP telephone terminal 4, and the output intended party number is displayed on a display unit (not illustrated) of the IP telephone terminal 4. The CPU 11 of the terminal server 1 stores the intended party number and the call origin party number in the intended party number field and the call origin party number field of the call record DB 152, respectively.

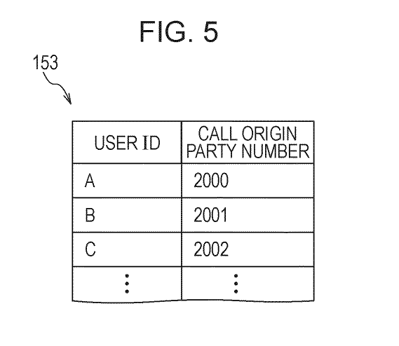

Upon receipt of the intended party number through the communication unit 16 as a trigger, the CPU 11 stores the date and time output from the clock unit 18 in the call record DB 152 as the call start time. When disconnection information is received from the IP-PBX 3 through the communication unit 16, the CPU 11 stores the date and time output from the clock unit 18 in the call record DB 152 as the call end time. FIG. 5 illustrates a record layout of the user DB 153. The user DB 153 stores call origin party numbers in association with user IDs.

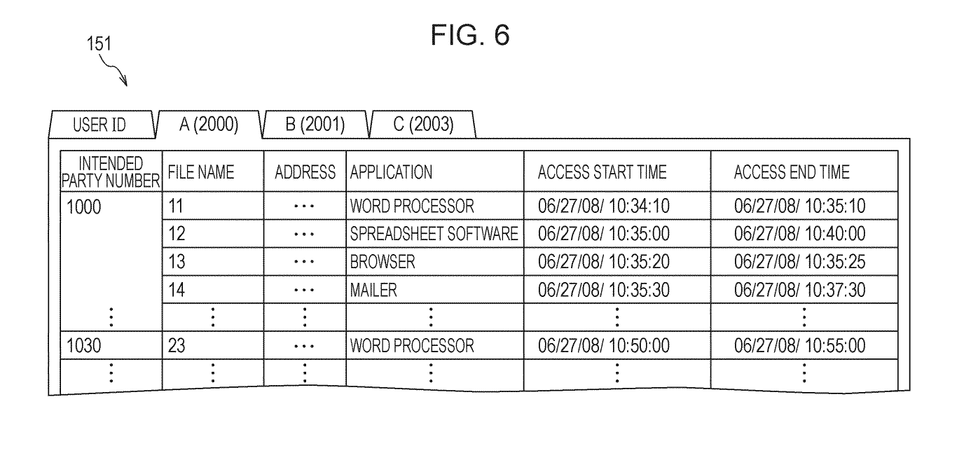

FIG. 6 illustrates a record layout of the operation record file 151. The operation record file 151 stores file operation records for each user ID. The example of FIG. 6 illustrates file operation records indicating files operated by the user with user ID “A” and call origin party number “2000” during calls with users with intended party numbers “1000”, “1030”, and so on. The operation record file 151 includes an intended party number field, a file name field, an address field, an application field, an access start time field, an access end time field, and other suitable fields. The intended party number field stores calling party numbers. The address field stores addresses of files operated using the input unit 23 of the computer 2 in association with the intended party numbers. The file name field stores file names entered by the user using the input unit 23.

The application field stores the types of the applications 154 that have been executed in connection with the files. Examples of the applications 154 include word processor software such as Microsoft Word (registered trademark), spreadsheet software such as Microsoft Excel (registered trademark), browsers such as Microsoft Internet Explorer (registered trademark), and mailers. The examples of the applications 154 are merely examples, and one of them may be used or other applications capable of running on computers, such as a Portable Document Format (PDF) reader, may also be included. Files created by using the applications 154 are stored in the file DB 155 in association with user IDs. The addresses of the files contain information about locations in the file DB 155 where the files associated with the applications 154 activated by the user using the input unit 23 are stored. The addresses of the files are represented by, for example, the path of the file DB 155, Uniform Resource Locator (URL), or the like. Note that the address of a Web page opened in a browser may be URL or, if cached, may contain the path of the cache directory. In the following description, it is assumed that the addresses of files are represented using path notation.

Upon receipt of the intended party number as a trigger, the CPU 11 stores the file names and addresses of files opened in the individual applications 154 and the applications 154 in the operation record file 151 so as to be associated with the intended party number for a period until disconnection information has been received. The CPU 11 stores records of operations related to the files in association with the intended party number and the call origin party number. The CPU 11 further refers to the information output from the clock unit 18 and stores the date and time when each of the files is opened (hereinafter referred to as “access start time”) in the access start time field. Likewise, the CPU 11 refers to the information output from the clock unit 18 and stores the date and time when each of the files is closed (the file operation was terminated) (hereinafter referred to as “access end time”) in the access end time field. If a file is open when disconnection information is received through the communication unit 16, the CPU 11 stores the date and time when the disconnection information is received in the access end time field.

The record layouts described above of the operation record file 151, the call record DB 152, and the like are merely examples, and other record layouts may be used. Any data configuration may be used as far as the relationship between data items can be maintained. Therefore, operation records of files remotely operated using the input unit 23 during a call are sequentially stored in association with the intended party number which is identification information. In the example of FIG. 6, it can be understood that, for example, for the period from Jun. 27, 2008 at 10:34 a.m. to the same day at 10:40 a.m. during which a call is made between the device with intended party number “1000” and the device with call origin party number “2000”, the text file with file name “11” is opened at 10:34:10 a.m. on the same day and closed at 10:35:10 a.m. on the same day.

After the disconnection, when a communication is established again between the IP telephone terminals 5 and 4, the CPU 11 performs the following processes. The CPU 11 receives the intended party number and the call origin party number from the IP-PBX 3. The CPU 11 searches through the operation record file 151 on the basis of the received intended party number and call origin party number. The CPU 11 reads the address and file name of a file stored under the AND condition of the intended party number and the call origin party number.

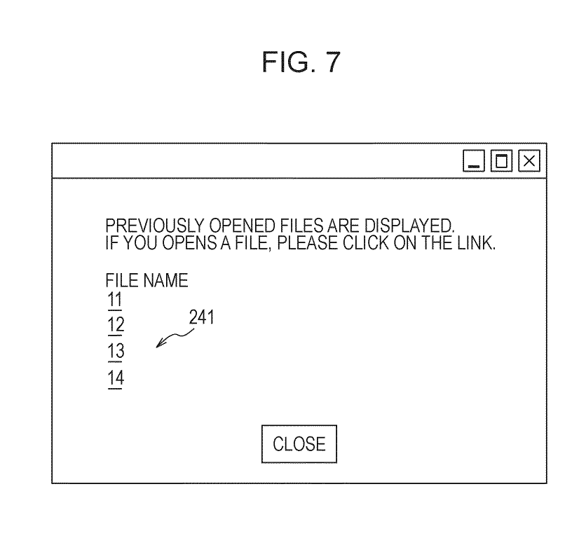

FIG. 7 illustrates an image of a guide screen. A template for the guide screen is stored in the storage unit 15. The CPU 11 reads the template for the guide screen, and embeds links 241 containing addresses for accessing read files in the template to generate a guide screen. The links 241 are identified by file names. The CPU 11 outputs the generated guide screen to the computer 2. Upon receipt of the guide screen, the CPU 21 of the computer 2 displays the guide screen, as illustrated in, for example, FIG. 7, on the display unit 24.

The user clicks on one of the links 241, which is associated with a file that the user desires to activate, using the input unit 23 while viewing the guide screen displayed during the call. When the click on the link 241 from the input unit 23 is accepted, the CPU 21 outputs the address specified by the link 241 and an output request for outputting the file associated with the link 241 to the terminal server 1. When the address and the output request are accepted, the CPU 11 of the terminal server 1 refers to the extension or the like of the address and activates the corresponding one of the applications 154 to open a file. The CPU 11 outputs the window of the opened file to the computer 2. Therefore, a file opened during a previous call can be opened in a similar manner, and a call can be more smoothly made.

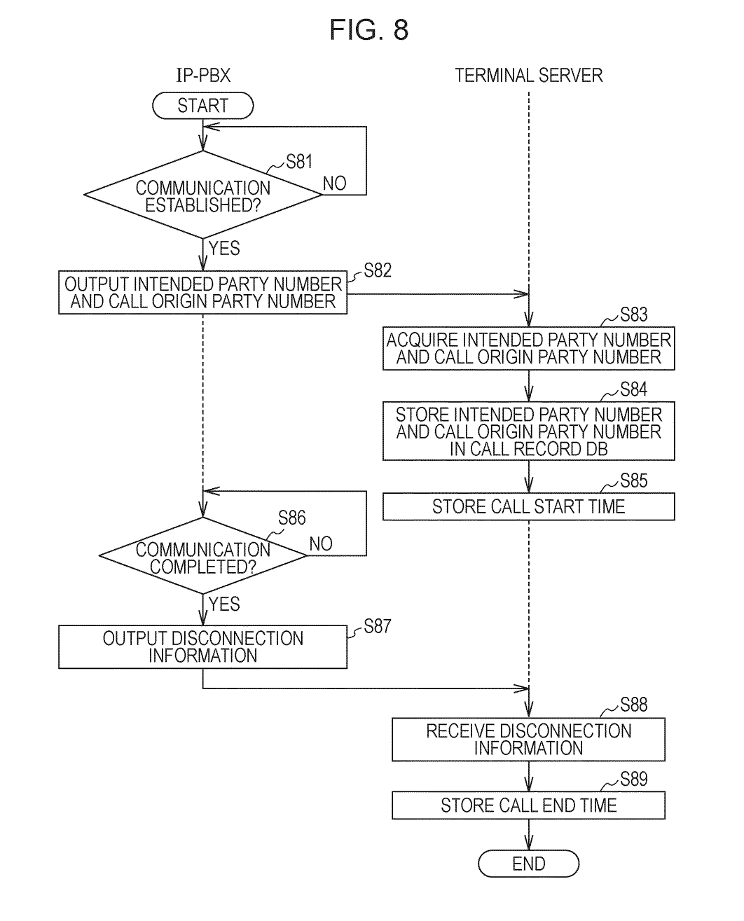

The processing procedure for storing an operation record and the processing procedure for displaying a link in the hardware described above will be described with reference to flowcharts. FIG. 8 illustrates a processing for acquiring an intended party number. The IP-PBX 3 determines whether or not a communication has been established between the IP telephone terminals 5 and 4 (operation S81). While the description will be given of the case where, by way of example, the IP telephone terminal 5 which is the intended party initiates a call and the IP telephone terminal 4 which is the call origin party receives the call, other examples may be used. Conversely, the IP telephone terminal 4 which is the call origin party may initiate a call and the IP telephone terminal 5 which is the intended party may receive the call. If it is determined that no communication has been established (NO in operation S81), the IP-PBX 3 waits for a communication to have been established.

If it is determined that a communication has been established (YES in operation S81), the IP-PBX 3 outputs the intended party number and the call origin party number to the terminal server 1 (operation S82). The CPU 11 of the terminal server 1 acquires the output intended party number and call origin party number through the communication unit 16 (operation S83). The CPU 11 stores the acquired intended party number and call origin party number in the call record DB 152 (operation S84). The CPU 11 further refers to the information output from the clock unit 18 and stores the call start time in the call record DB 152 (operation S85).

The IP-PBX 3 continues to monitor the communication state of the IP telephone terminals 4 and 5, and determines whether or not the communication has been completed (operation S86). If it is determined that the communication has not been completed (NO in operation S86), the IP-PBX 3 continues to monitor the communication state. If it is determined that the communication has been completed (YES in operation S86), the IP-PBX 3 outputs disconnection information to the terminal server 1 (operation S87). The CPU 11 of the terminal server 1 receives the disconnection information through the communication unit 16 (operation S88). The CPU 11 stores the call end time in the call record DB 152 (operation S89).

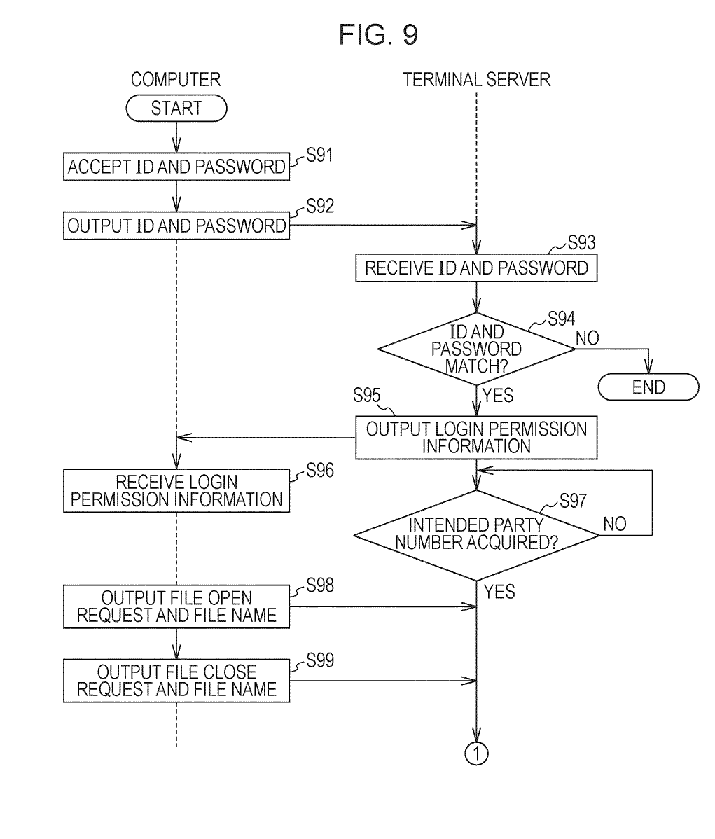

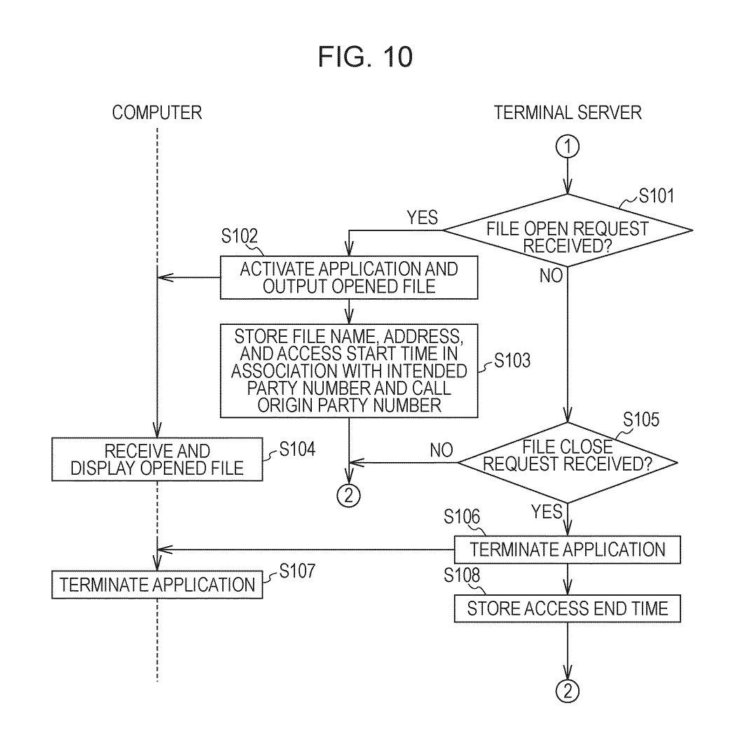

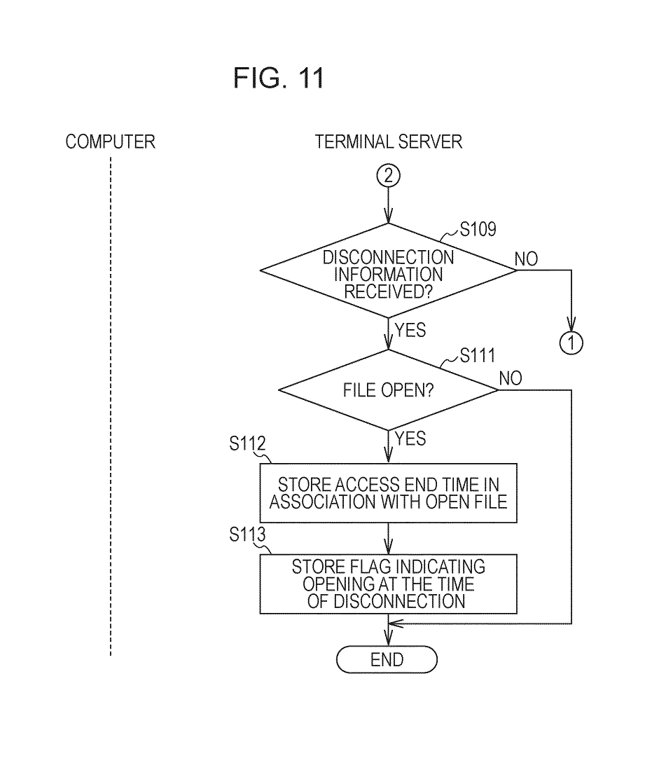

FIGS. 9 to 11 illustrate a processing for storing a file operation record. The CPU 21 of the computer 2 accepts the ID and password for login to the terminal server 1 from the input unit 23 (operation S91). The CPU 21 outputs the ID and the password to the terminal server 1 through the communication unit 26 (operation S92). The CPU 11 of the terminal server 1 receives the ID and the password through the communication unit 16 (operation S93). The CPU 11 determines whether or not the received ID and password match any of IDs and passwords stored in advance in the storage unit 15 (operation S94).

If it is determined that the ID and the password do not match any of the IDs and passwords (NO in operation S94), the CPU 11 determines that the access is unauthorized and the process ends. If it is determined that the ID and the password match any of the IDs and passwords (YES in operation S94), the CPU 11 outputs information indicating the permission of login to the computer 2 (operation S95). The computer 2 receives the information indicating the permission of login (operation S96). Therefore, the computer 2 can remotely operate files associated with the applications 154 in the terminal server 1.

The CPU 11 determiners whether or not the intended party number has been acquired from the IP-PBX 3 (operation S97). If it is determined that the intended party number has not been acquired from the IP-PBX 3 (NO in operation S97), the CPU 11 waits for the intended party number to have been acquired. If it is determined that the intended party number has been acquired from the IP-PBX 3 (YES in operation S97), the CPU 11 proceeds to operation S101. The user accesses the files stored in the file DB 155 using the computer 2 through the input unit 23. In this case, the CPU 21 outputs a request for opening a file and the file name of the file to be opened to the terminal server 1 by using the input unit 23 (operation S98).

The CPU 21 also outputs a request for closing a file and the file name of the file to be closed to the terminal server 1 by using the input unit 23 (operation S99). The CPU 11 of the terminal server 1 determines whether or not a request for opening a file stored in the file DB 155 has been received (operation S101). If it is determined that a request for opening a file has been received (YES in operation S101), the CPU 11 activates the corresponding one of the applications 154 associated with the file to open a file and outputs the opened file to the computer 2 through the communication unit 16 (operation S102). The CPU 11 stores the file name and the address of the file, and the access start time in the operation record file 151 in association with the intended party number and call origin party number acquired in operation S83 (operation S103).

The CPU 21 of the computer 2 receives the opened file, and displays the file on the display unit 24 (operation S104). When no request has been received for opening a file (NO in operation S101), the CPU 11 of the terminal server 1 determines whether or not a request for closing a file has been received (operation S105). If it is determined that a request for closing a file has been received (YES in operation S105), the CPU 11 terminates the corresponding one of the applications 154 associated with the file (operation S106). Accordingly, the CPU 21 of the computer 2 terminates the application 154 (operation S107).

The CPU 11 of the terminal server 1 refers to the information output from the clock unit 18 and stores the access end time in association with the access start time stored in operation S103 (operation S108). If it is determined that no request has been received for closing a file (NO in operation S105), the CPU 11 determines whether or not the disconnection information output in operation S87 has been received (operation S109). If it is determined that the disconnection information has not been received (NO in operation S109), the CPU 11 returns the process to operation S101. The above process is repeated to sequentially accumulate records of operations on the files accessed in the file DB 155 during the call in the operation record file 151.

If it is determined that the disconnection information has been received from the IP-PBX 3 (YES in operation S109), the CPU 11 determines whether or not there is a file that is open (operation S111). If it is determined that there is no file that is open (NO in operation S111), the CPU 11 ends the series of processes. If it is determined that there is a file that is open (YES in operation S111), the CPU 11 stores the access end time in the operation record file 151 in association with the file name of the open file (operation S112). The CPU 11 stores a flag indicating that a file is open at the time of disconnection in the operation record file 151 so that the flag is associated with the file name stored in operation S112 (operation S113). In an embodiment, by way of example, an operation record is stored in the operation record file 151 in real time during a call. However, other examples may be used. Access start times and access end times may be stored in association with file names, and, after the end of a call, the file names of files accessed for the period from the call start time to the call end time may be stored in association with the intended party number and the call origin party number. In an embodiment, furthermore, by way of example, operation records generated for the period from the acquisition of the intended party number to the reception of disconnection information are stored. However, other examples may be used. For example, operation records generated for the period until a certain period of time has elapsed from the acquisition of the intended party number may be stored. In this case, after the acquisition of the intended party number, the CPU 11 may access the clock unit 18 and may store, for example, operation records generated within five minutes.

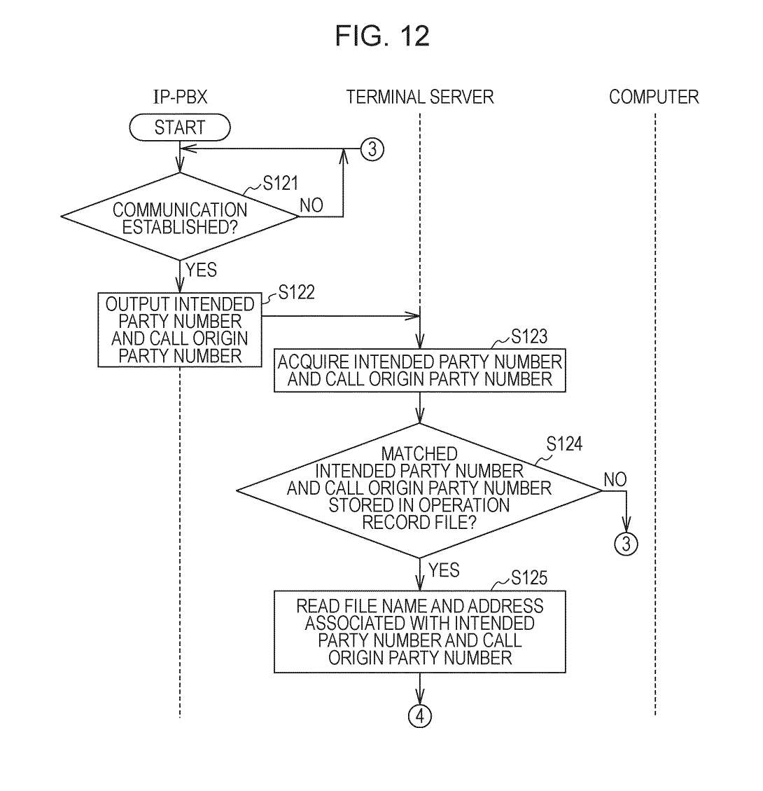

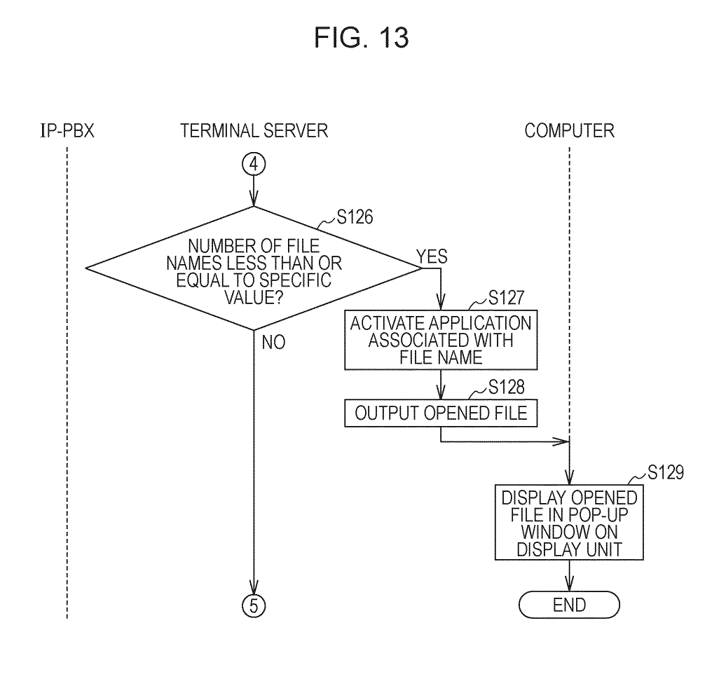

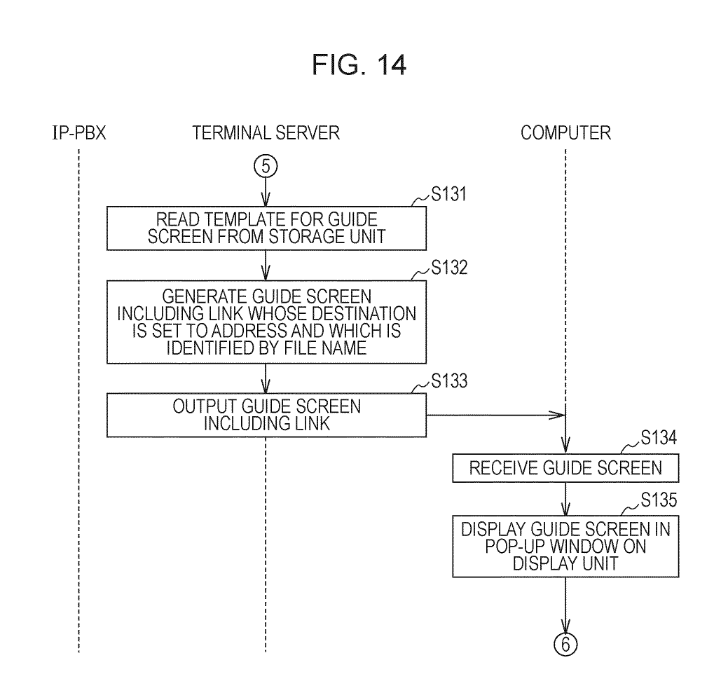

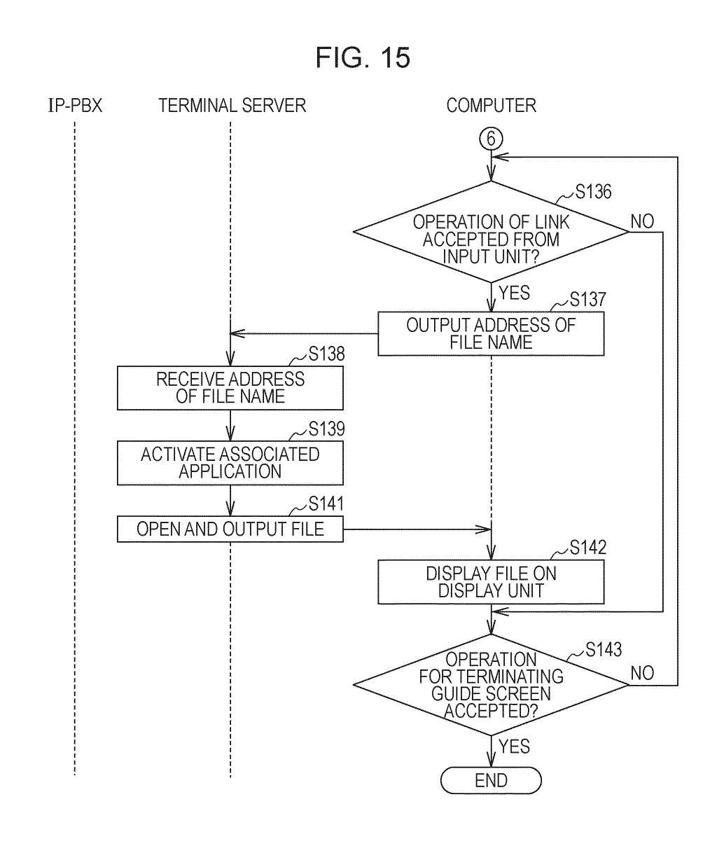

FIGS. 12 to 15 illustrate a processing for displaying, during a call, information about a file relating to a previous call. It is assumed that the computer 2 has already logged in to the terminal server 1. After disconnection information is output in operation S87 (FIG. 8), the IP-PBX 3 determines whether or not a communication has been established again between the IP telephone terminals 4 and 5 (operation S121). If it is determined that no communication has been established (NO in operation S121), the IP-PBX 3 waits for a communication to have been established. If it is determined that a communication has been established (YES in operation S121), the IP-PBX 3 outputs the intended party number and the call origin party number to the terminal server 1 (operation S122).

The CPU 11 of the terminal server 1 acquires the intended party number and the call origin party number through the communication unit 16 (operation S123). The CPU 11 determines whether or not the intended party number and call origin party number that respectively match the acquired intended party number and call origin party number are stored under the AND condition in the operation record file 151 (operation S124). If it is determined that no matched intended party number or call origin party number is stored (NO in operation S124), the CPU 11 determines that there has been no previous call made between such a combination of intended party number and call origin party number, and returns the process to operation S121.

If it is determined that the matched intended party number and call origin party number are stored (YES in operation S124), the CPU 11 reads a file name and an address that are associated with the intended party number and the call origin party number from the operation record file 151 (operation S125). The CPU 11 determines whether or not the number of file names read here is less than or equal to a specific value (operation S126). The specific value is, for example, 3 and is stored in the storage unit 15. A desired value can be stored as the specific value using the input unit 13.

If it is determined that the number of file names is less than or equal to the specific value (YES in operation S126), the CPU 11 activates the applications 154 associated with the file names (operation S127). The CPU 11 outputs opened files to the computer 2 (operation S128). That is, the opened files themselves are output as information about the files to the computer 2. The CPU 21 of the computer 2 displays the opened files in a pop-up window on the display unit 24 (operation S129).

If it is determined that the number of file names is not less than or equal to the specific value (NO in operation S126), the CPU 11 of the terminal server 1 reads the template for the guide screen from the storage unit 15 (operation S131). The CPU 11 generates a guide screen including the links 241 whose destinations are set to the addresses and which are identified by the file names (operation S132). The CPU 11 generates the guide screen including the links 241 to the computer 2 (operation S133).

The computer 2 receives the guide screen (operation S134). The CPU 21 of the computer 2 displays the guide screen on the display unit 24 in a pop-up window as illustrated in, for example, FIG. 7 (operation S135). The CPU 21 determines whether or not an operation of one of the links 241 has been accepted from the input unit 23 (operation S136). If it is determined that an operation of one of the links 241 has been accepted (YES in operation S136), the CPU 21 outputs the address of the file name to the terminal server 1 (operation S137). The CPU 11 of the terminal server 1 receives the address of the file name (operation S138).

The CPU 11 activates the corresponding one of the applications associated with the address of the file name (operation S139). The CPU 11 opens a file and outputs the file to the computer 2 (operation S141). The CPU 21 of the computer 2 displays the opened file on the display unit 24 (operation S142). After the processing of operation S142 or if it is determined that an operation of one of the links 241 has not been accepted from the input unit 23 (NO in operation S136), the CPU 21 determines whether or not the operation for terminating the guide screen has been accepted (operation S143). This determination may be performed by determining whether or not the operation of the “close” button in the guide screen illustrated in FIG. 7 has been accepted from the input unit 23.

If it is determined that the operation for termination has not been accepted (NO in operation S143), the CPU 21 proceeds to operation S136 and again determines whether or not an operation of one of the links 241 has been accepted. If it is determined that the operation for termination has been accepted (YES in operation S143), the CPU 21 ends the series of processes. Therefore, information about a file accessed in a previous call can be displayed during a call, and reduction in time and quicker communication can be achieved. In addition, when the number of file names is small, the corresponding files are directly displayed, thus allowing quick handling. When the number of desired files is large, the links 241 are displayed, thus providing information about a call without impairing visibility and quickness.

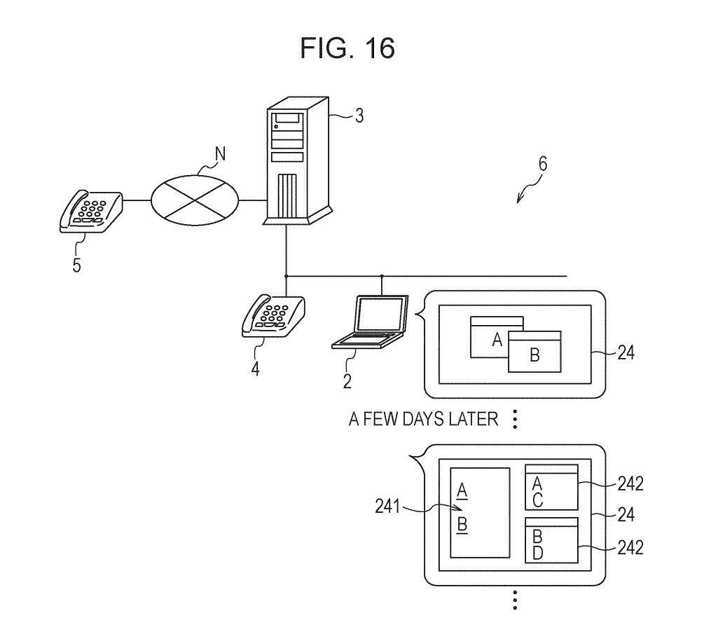

An embodiment relates to the display of information about a previous call using a local computer 2. FIG. 16 illustrates an overview of an output system according to an embodiment. Unlike the above-described embodiment, the computer 2 serves as an information processing apparatus and executes processes similar to those of the terminal server 1 of the above-described embodiment. An embodiment also relates to the display of, in addition to links 241, a folder including a file relating to a previous call and files included in the folder on a display unit 24. In the example of FIG. 16, in addition to the display of links 241 for accessing files A and B, information of a folder 242 including the file A and a folder 242 including the file B are also displayed.

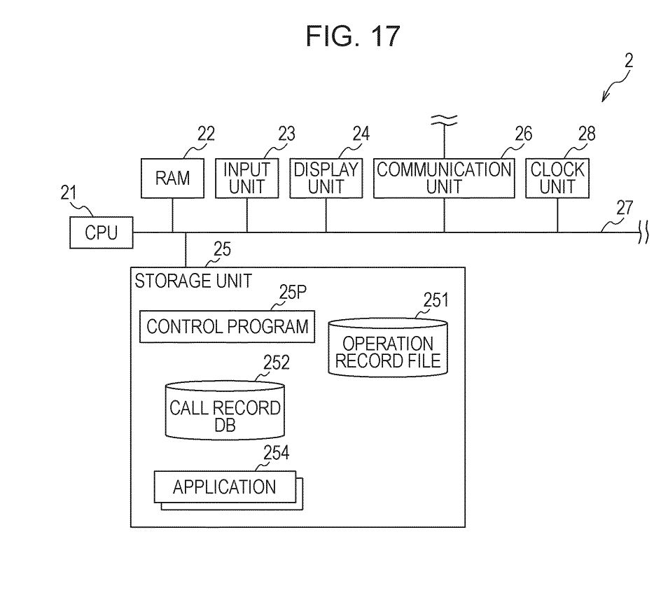

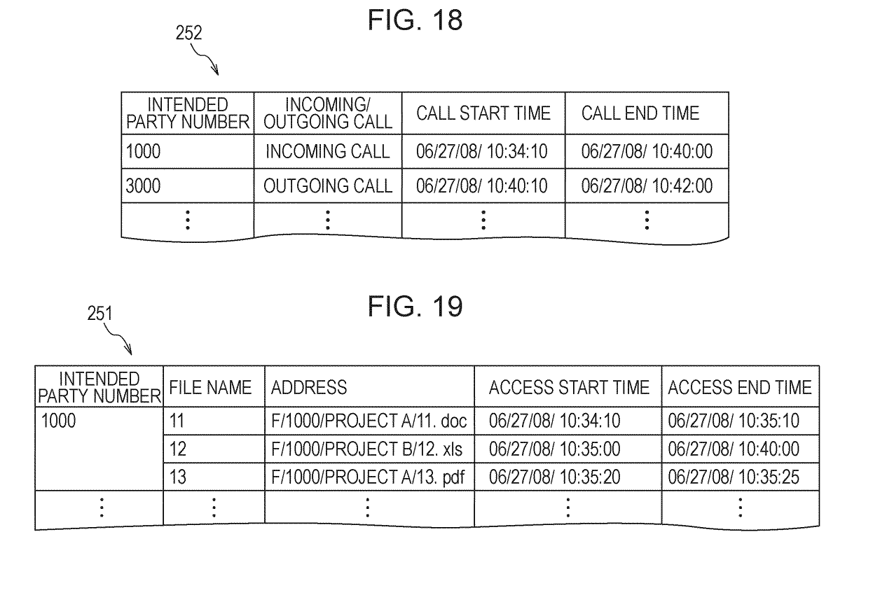

FIG. 17 is a block diagram of the hardware of the computer 2 according to an embodiment. A clock unit 18 outputs date and time information to a CPU 21. A storage unit 25 stores a control program 25P for executing various processes, a call record DB 252, application(s) 254, an operation record file 251, and the like. The storage unit 25 further stores folders 242 for classifying and organizing files created by using the applications 254 although the folders 242 are not illustrated in FIG. 17. FIG. 18 illustrates a record layout of the call record DB 252. The call record DB 252 includes an intended party number field, an incoming/outgoing call field, a call start time field, a call end time field, and other suitable fields.

The call record DB 252 stores information indicating whether an IP telephone terminal 4 in a LAN 6 has made or received a call, the call start time, and the call end time in association with the intended party number. FIG. 19 illustrates a record layout of the operation record file 251 according to an embodiment. The operation record file 251 includes an intended party number field, a file name field, an address field, an access start time field, an access end time field, and other suitable fields. The address field stores the address (path) of a file operated during the call.

For example, a file with file name “11” has address “F/1000/PROJECT A/11.doc”. In an embodiment, the address is configured using drive name “F”, which designates the storage unit 25 such as a hard disk, as its root followed by the description of the folder 242 and the file using the absolute path, by way of example. The file with file name “11” is stored in the “PROJECT A” folder in the “1000” folder in the F: drive. The CPU 21 displays the folder 242 including a file that has been operated on the display unit 24.

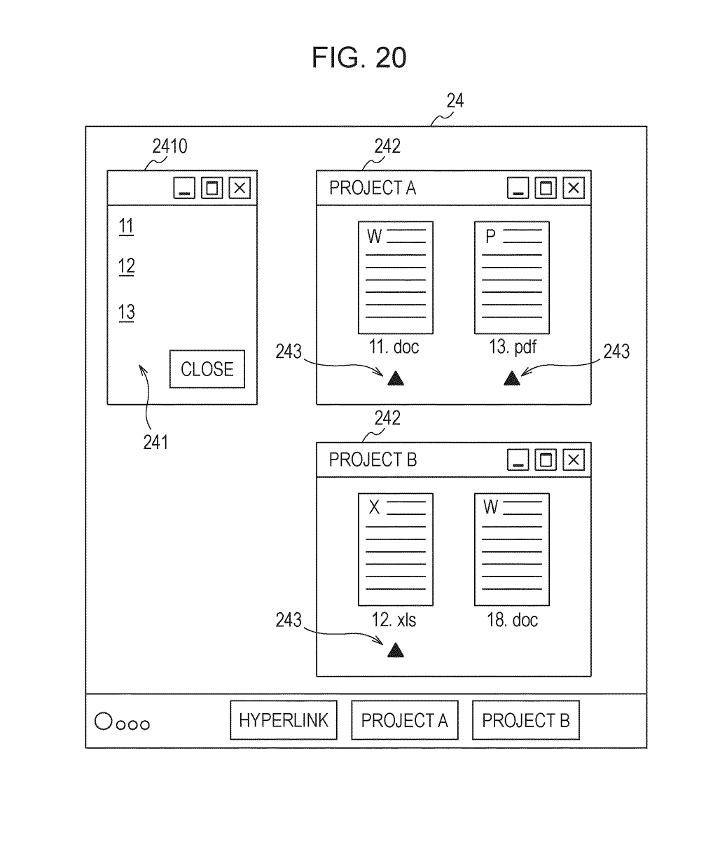

FIG. 20 illustrates an image of a guide screen according to an embodiment. In the guide screen, a link window 2410 including the links 241 described with respect to an embodiment and the folders 242 are displayed. The CPU 21 displays a folder 242 including a file to be displayed, which is provided in a hierarchy one level above the file, and files included in the folder 242. In other words, the CPU 21 displays a folder 242 in the bottom hierarchy among folders 242 including a file to be displayed, and also displays files included in the folder 242. In the example of FIG. 20, the “PROJECT A” folder 242 and files “11” and “13” in the “PROJECT A” folder 242 are displayed on the display unit 24.

Likewise, the “PROJECT B” folder 242 and files “12” and “18” in the “PROJECT B” folder 242 are displayed. All the files in the folders 242, except for files having links 241, such as file “18” illustrated in FIG. 20, may be displayed. In an embodiment, furthermore, the link window 2410 and the folders 242 are displayed on the display unit 24, by way of example. However, other examples may be used. For example, depending on the number of folders 242, the link window 2410 may not necessarily be displayed. In this case, the CPU 21 may perform a process for identifying a desired file in the folders 242 from the other files (hereinafter referred to as an “identification process”).

The identification process may be, for example, a process for coloring the desired file, marking the desired file with a distinguishable icon, adding a text message such as “this file was operated in the previous call” near the desired file, flashing the icon of the desired file, or the like. In an embodiment, as illustrated in FIG. 20, in the identification process, by way of example, a black triangle mark 243 (indicator) is added near the icon or name of the desired file. In this example, marks 243 are added to files “11”, “13”, and “12” that are opened in the previous call.

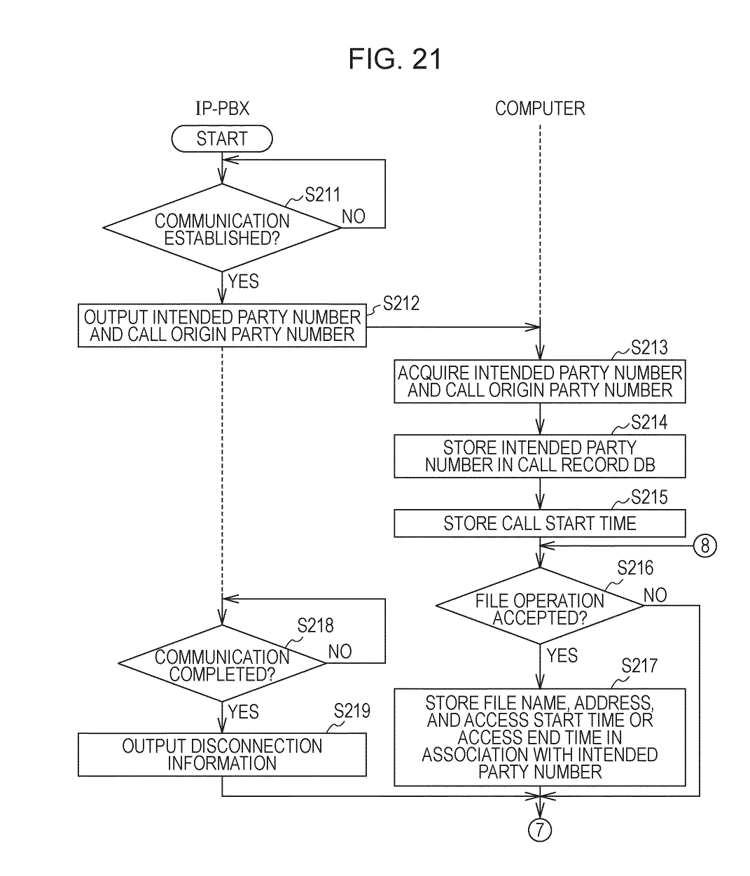

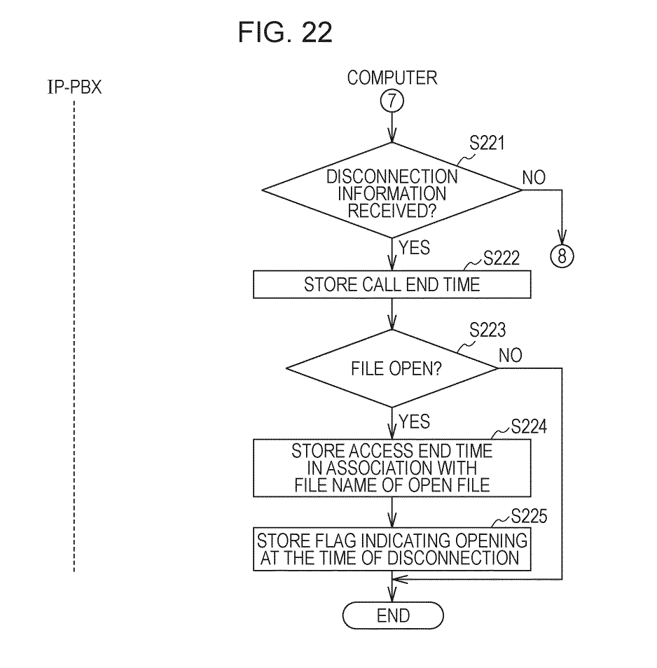

An output processing procedure performed in the above hardware will now be described with reference to a flowchart. FIGS. 21 and 22 illustrate a processing for storing an operation record. The IP-PBX 3 determines whether or not a communication has been established between the IP telephone terminals 5 and 4 (operation S211). If it is determined that no communication has been established (NO in operation S211), the IP-PBX 3 waits for a communication to have been established.

If it is determined that a communication has been established (YES in operation S211), the IP-PBX 3 outputs the intended party number and the call origin party number to the computer 2 (operation S212). The CPU 21 of the computer 2 acquires the output intended party number and call origin party number through the communication unit 26 (operation S213). The CPU 21 stores the acquired intended party number in the call record DB 252 (operation S214). The CPU 21 also refers to the information output from the clock unit 28 and stores the call start time in the call record DB 252 (operation S215).

The CPU 21 determines whether or not an operation of a file has been accepted from the input unit 23 (operation S216). Specifically, the CPU 21 determines whether or not the operation of opening or closing a document file stored in the storage unit 25, opening or closing a received or sent mail file in a Received folder, a Sent folder, or the like of a mailer, or any other operation has been performed. The CPU 21 further determines whether or not a file contained in a Web server computer connected via the communication network N has been downloaded and displayed in a browser or whether or not the display has been deleted by closing the browser. If it is determined that an operation of a file has been accepted (YES in operation S216), the CPU 21 stores the file name, the address, and the access start time or access end time in the operation record file 251 in association with the intended party number (operation S217).

Specifically, when a document file in the storage unit 25 is opened using the input unit 23, the CPU 21 stores the file name and the address (path) of the file, and the date and time when the file is opened, which is output from the clock unit 28, in the operation record file 251 in association with the intended party number. Similarly, when the above developed document file is closed using the input unit 23, the CPU 21 stores the date and time when the file is closed, which is output from the clock unit 28, in the operation record file 251 in association with the intended party number. When one received mail file in the Received folder in the storage unit 25 is opened using the input unit 23, the CPU 21 stores the file name and the address (path) of the file, and the date and time when the file is opened, which is output from the clock unit 28, in the operation record file 251 in association with the intended party number. Similarly, when the above developed received mail file is closed using the input unit 23, the CPU 21 stores the date and time when the file is closed, which is output from the clock unit 28, in the operation record file 251 in association with the intended party number.

When a browser is activated and a Hypertext Markup Language (HTML) file is downloaded, the CPU 21 stores the name of the Web page from which the HTML file is downloaded as a file name, and the URL for accessing the HTML file as an address in the operation record file 251 so as to be associated with a contact number. Note that the CPU 21 stores the download time of the HTML file as the access start time. When the browser in which the HTML file is displayed is terminated, the CPU 21 stores the access end time in the operation record file 251. In the following description, for simplicity of description, the operation of opening or closing a document file is used by way of example.

The IP-PBX 3 continues to monitor the communication state of the IP telephone terminals 4 and 5, and determines whether or not the communication has been completed (operation S218). If it is determined that the communication has not been completed (NO in operation S218), the IP-PBX 3 continues to monitor the communication state. If it is determined that the communication has been completed (YES in operation S218), the IP-PBX 3 outputs disconnection information to the computer 2 (operation S219).

If it is determined in operation S216 that no file operation has been accepted (NO in operation S216) or after the processing of operation S217, the CPU 21 determines whether or not the disconnection information has been received (operation S221). If it is determined that the disconnection information has not been received (NO in operation S221), the CPU 21 returns to operation S216, and accumulates file operation records.

If it is determined that the disconnection information has been received (YES in operation S221), the CPU 21 refers to the date and time output from the clock unit 28, and stores the call end time in the call record DB 252 (operation S222). The CPU 21 determines whether or not there is a file that is still opened after the disconnection information has been received (operation S223). If it is determined that there is no file that is open (NO in operation S223), the CPU 21 ends the series of processes. If it is determined that there is a file that is open (YES in operation S223), the CPU 21 stores the access end time in the operation record file 251 in association with the file name of the opened file (operation S224). The CPU 21 stores a flag indicating that a file is open at the time of disconnection in the operation record file 251 so that the flag is associated with the file name stored in operation S224 (operation S225).

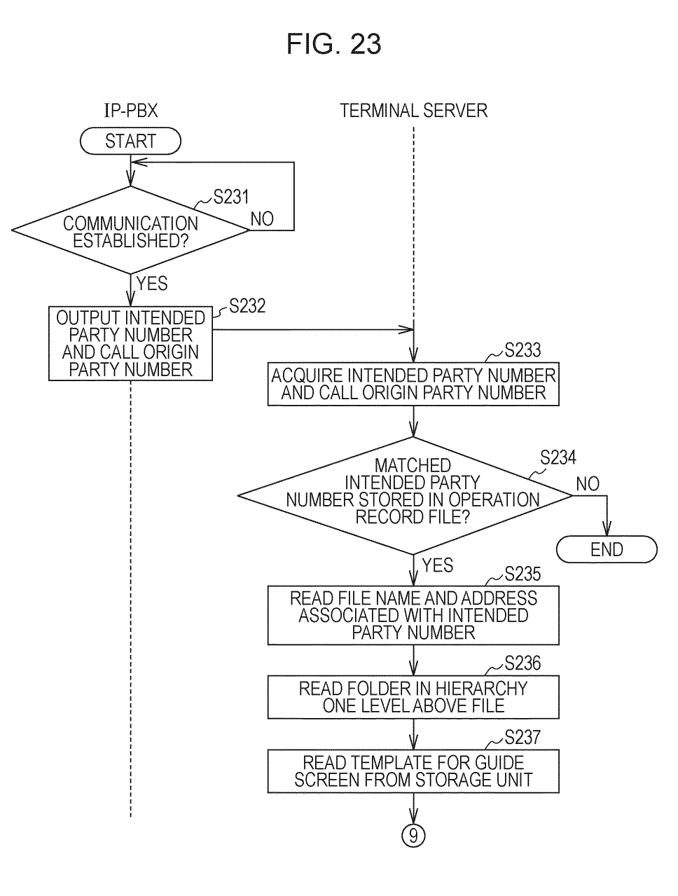

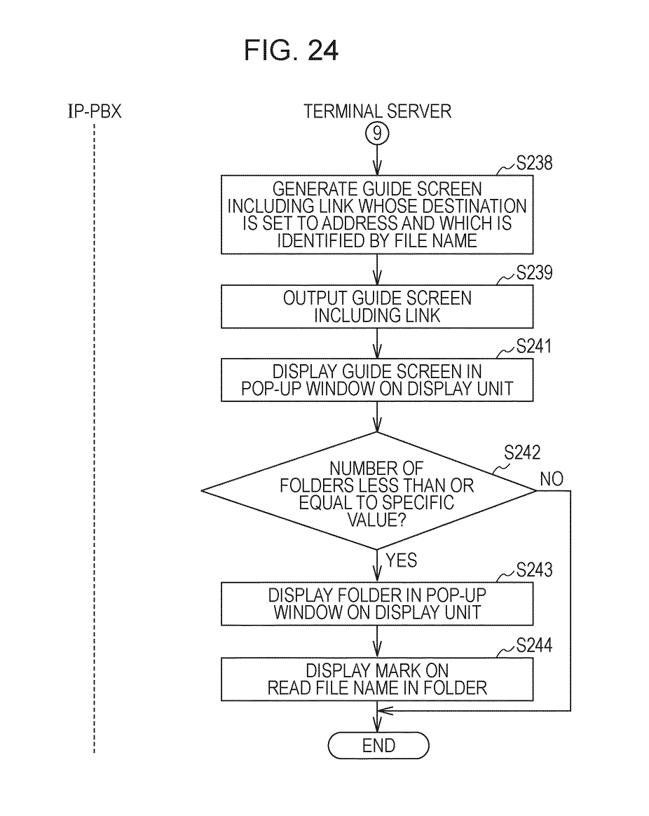

FIGS. 23 and 24 illustrate a processing for display. The IP-PBX 3 determines whether or not a communication has been established between the IP telephone terminals 5 and 4 (operation S231). If it is determined that no communication has been established (NO in operation S231), the IP-PBX 3 waits for a communication to have been established.

If it is determined that a communication has been established (YES in operation S231), the IP-PBX 3 outputs the intended party number and the call origin party number to the computer 2 (operation S232). The CPU 21 of the computer 2 acquires the intended party number and the call origin party number through the communication unit 26 (operation S233). The CPU 21 determines whether or not the intended party number that matches the acquired intended party number is stored in the operation record file 251 (operation S234). If it is determined that no matched intended party number is stored (NO in operation S234), the CPU 21 ends the process.

If it is determined that the matched intended party number is stored (YES in operation S234), the CPU 21 reads a file name and an address that are associated with the intended party number from the operation record file 251 (operation S235). The CPU 21 reads a folder 242 that is provided in the hierarchy one level above the read file (operation S236). The CPU 21 reads a template for a guide screen from the storage unit 25 (operation S237). The CPU 21 generates a guide screen including a link 241 whose destination is set to the read address and which is identified by the file name (operation S238). The CPU 21 generates the guide screen including the link 241 to the display unit 24 (operation S239).

The CPU 21 displays the guide screen in a pop-up window on the display unit 24 (operation S241). The CPU 21 determines whether or not the number of folders read in operation S236 is less than or equal to a specific value (operation S242). The specific value may be, for example, 2. The specific value may be set by entering a desired value using the input unit 23, and can be stored in the storage unit 25. If it is determined that the number of folders is not less than or equal to the specific value (NO in operation S242), the CPU 21 ends the series of processes in order to prevent a large number of folders 242 from being displayed on the display unit 24. In this case, only the link window 2410 obtained in operation S241 is displayed.

If it is determined that the number of folders is less than or equal to the specific value (YES in operation S242), the CPU 21 displays the folders 242 read in operation S236 in a pop-up window on the display unit 24 (operation S243). The CPU 21 displays the file names of files in the folders 242 or the icons of the files and also displays the folders 242 read in operation S236 on the display unit 24 after the marks 243 are added to the file names of the files in the read folders 242 (operation S244). Therefore, operation records indicating operations generated during the call using the local computer 2 can be stored, and information about files that have been previously operated can be displayed during another call with the same intended party. Depending on the number of folders 242, files in the folders 242 are also displayed so that both a given file that has been operated and files that is in the same folder as that of the given file and that has strong relevance to the given file can also be displayed as information.

Detailed description of similar features of embodiments having corresponding portions assigned the same reference numerals is omitted.

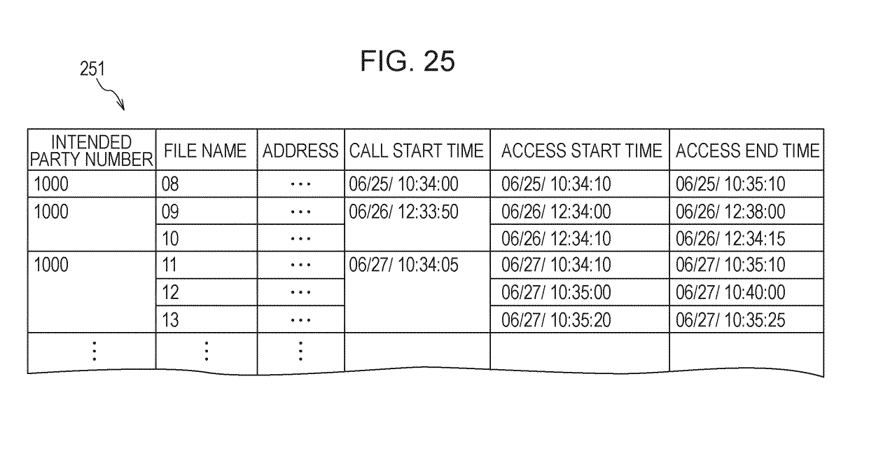

An embodiment relates to the preferential display of files associated with a specified number of calls or associated with calls made within a specified number of days. While description will be given of the case where the local computer 2 described with respect to the above-identified embodiment executes various processes, the various processes may be executed by the terminal server 1 described with respect to the above-described embodiment. FIG. 25 illustrates a record layout of an operation record file 151. As illustrated in FIG. 25, file names, addresses, and the like of files that have been operated in time series in order of the access start time are stored in association with an intended party number. The call start times corresponding to the respective files are also stored. In the example of FIG. 25, it can be understood that files with file names “11” to “13” are operated during a call made on June 27 (hereinafter referred to as “the previous call”) and that files with file names “09” and “10” are operated during a call made on June 26 (hereinafter referred to as “the further previous call”). It can also be understood that a file with file name “08” is operated during a call on June 25 (hereinafter referred to as “the still further previous call”).

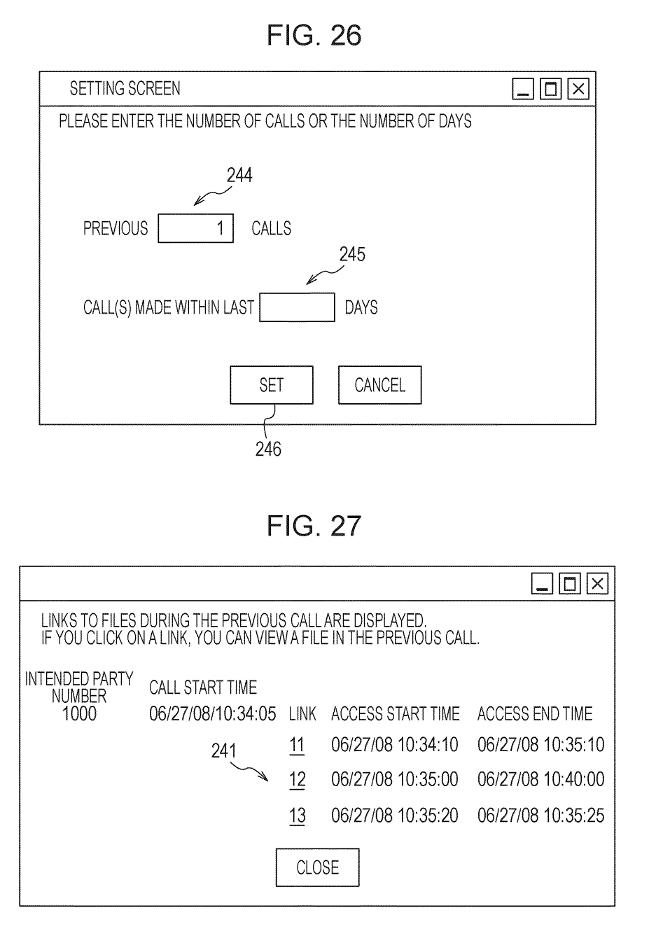

FIG. 26 illustrates an image of a setting screen. The CPU 21 reads a setting screen stored in the storage unit 25, and displays the setting screen on the display unit 24. A user enters a desired value indicating the number of calls or the number of days for which files are to be displayed using the input unit 23 while referring to the setting screen. As illustrated in FIG. 26, a number-of-calls input box 244, a number-of-days input box 245, a set button 246, and the like are displayed. In the number-of-calls input box 244, the number of previous calls for which files are to be displayed is entered. For example, when value “1” is entered as the desired number of calls for display, information about files stored in the operation record file 251 while the previous one call is made is displayed. When value “2” is entered as the desired number of calls for display, information about files stored in the operation record file 251 while the previous two calls, namely, the previous call and the further previous call, are made is displayed. Similarly, when value “3” is entered as the desired number of calls for display, information about files stored in the operation record file 251 while the previous three calls, namely, the previous call, the further previous call, the still further previous call, are made is displayed.

In the number-of-days input box 245, the number of days for which files associated with previous calls are desired to be displayed is entered. For example, when value “3” is entered as the number of days, information about files having call times that are within three days prior to the current call time is displayed. When the set button 246 is clicked on using the input unit 23, the CPU 21 stores the value (the number of calls) entered in the number-of-calls input box 244 or the value (the number of days) entered in the number-of-days input box 245 in the storage unit 25.

FIG. 27 illustrates a displayed image including links 241 that are displayed during a call. FIG. 27 illustrates an example where value “1” is entered in the number-of-calls input box 244 so that the previous call is selected as a target call for which files are to be displayed. The CPU 21 refers to the operation record file 251, and reads the files names and addresses of files associated with the selected item and value, which are stored in the storage unit 25, to generate links 241. In the example of FIG. 27, the links 241 to files “11” to “13” operated during the previous call, namely, during the call made on June 27, are displayed. In an embodiment, in order to facilitate understanding of the preceding operation on the basis of time, the intended party number, the call start time, the access start time, and the access end time are also displayed on the display unit 24. The CPU 21 reads the intended party number, the call start time, the access start time, and the access end time of the files associated with the displayed links 241 from the operation record file 251, and displays them on the display unit 24.

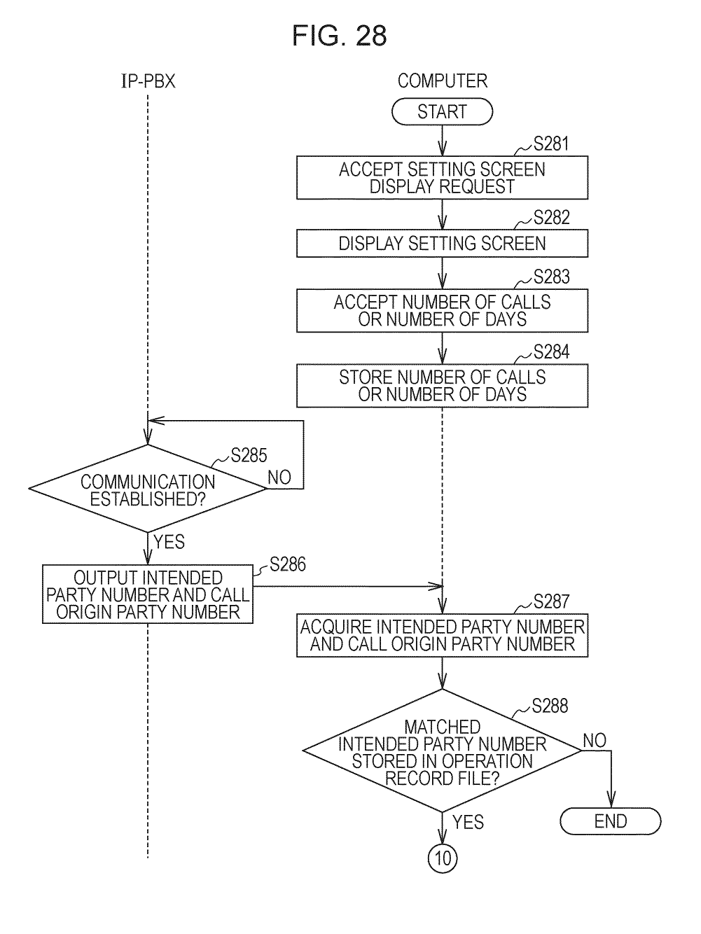

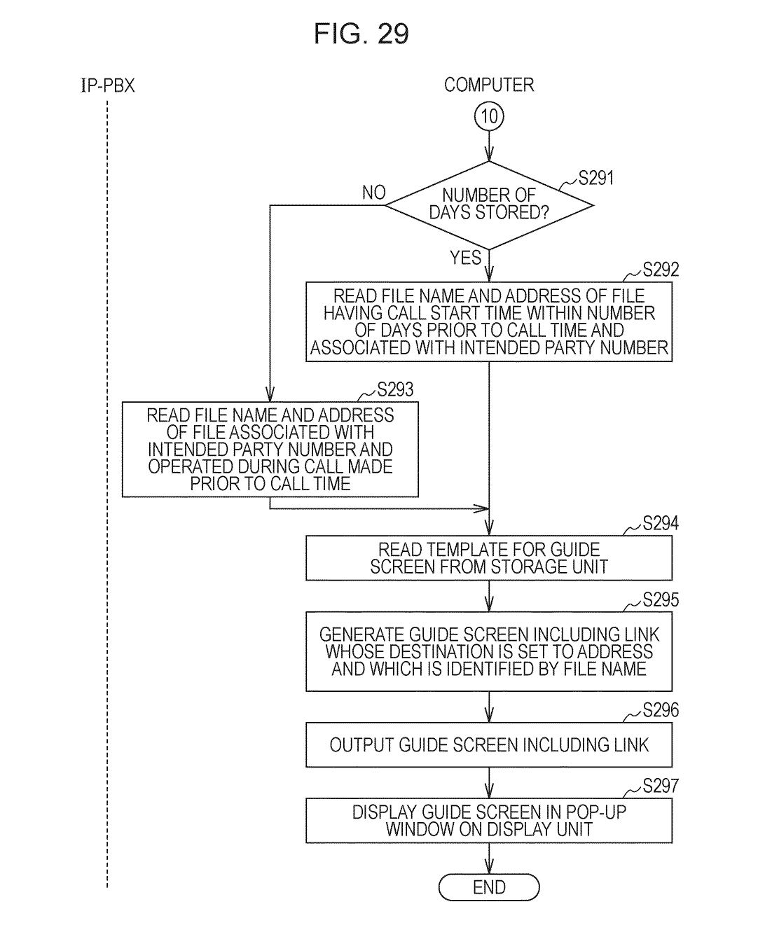

FIGS. 28 and 29 illustrate a processing for displaying according to an embodiment. The CPU 21 accepts a request for displaying the setting screen illustrated in FIG. 26 from the input unit 23 (operation S281). The CPU 21 displays the setting screen on the display unit 24 (operation S282). The CPU 21 accepts the number of calls or the number of days from the input unit 23 (operation S283). The CPU 21 stores the accepted number of calls or days in the storage unit 25 (operation S284).

A process performed when a call is made again after the settings described above have been made and after the processing of operations S211 to S225 has been performed will now be described. The IP-PBX 3 determines whether or not a communication has been established between the IP telephone terminals 5 and 4 (operation S285). If it is determined that no communication has been established (NO in operation S285), the IP-PBX 3 waits for a communication to have been established.

If it is determined that a communication has been established (YES in operation S285), the IP-PBX 3 outputs the intended party number and the call origin party number to the computer 2 (operation S286). The CPU 21 of the computer 2 acquires the output intended party number and call origin party number through the communication unit 26 (operation S287). The CPU 21 determines whether or not the intended party number that matches the acquired intended party number is stored in the operation record file 251 (operation S288). If it is determined that no matched intended party number is stored (NO in operation S288), the CPU 21 ends the process.

If it is determined that the matched intended party number is stored (YES in operation S288), the CPU 21 determines whether or not the storage unit 25 stores the number of days (operation S291). If it is determined that the storage unit 25 stores the number of days (YES in operation S291), the CPU 21 reads the file names and addresses of files having call start times that are within the number of days prior to the current call time and associated with the intended party number (operation S292).

If it is determined that the storage unit 25 does not store the number of days (NO in operation S291), the CPU 21 reads the file names and addresses of files associated with the intended party number and operated during the call made prior to the current call time from the operation record file 251 (operation S293). The CPU 21 reads a template for a guide screen from the storage unit 25 (operation S294). The CPU 21 generates a guide screen including links 241 whose destinations are set to the addresses read in operation S292 or S293 and which are identified by the file names (operation S295).

The CPU 21 generates the guide screen including the links 241 to the display unit 24 (operation S296). The CPU 21 displays the guide screen in a pop-up window on the display unit 24 (operation S297), and ends the process. Therefore, information about files operated during the recent call can be displayed so that extraction of information can be facilitated. Furthermore, the number of calls or the number of days can be set by user setting, and flexible display according to the frequency of occurrence of calls or the like can be achieved.

Since other features of one embodiment are similar to those of other embodiments, corresponding portions are assigned the same reference numerals and detailed description thereof is thus omitted.

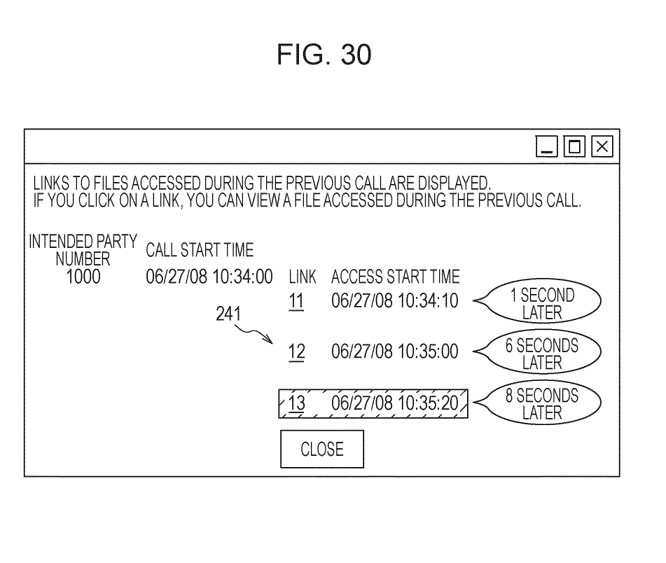

An embodiment relates to the fast-forward viewing of links 241 on the basis of the access start time. FIG. 30 illustrates a displayed image including the links 241. After a guide screen is output, a CPU 21 outputs the links 241 on the basis of the elapsed times from the call start times to the access start times. Specifically, the CPU 21 corrects the elapsed times and outputs the links 241 on the basis of the corrected elapsed times. For example, since the link 241 to file “11” is accessed 10 seconds after the call start time, the elapsed time is multiplied by a coefficient of 0.1 for correction. Thus, the link 241 is displayed one second later. Since file “12” is accessed 60 seconds after the call start time, the link 241 to file “12” is output six seconds later.

Similarly, since the link 241 to file “13” is accessed 80 seconds after the call start time, the CPU 21 outputs the link 241 eight seconds later. In an embodiment, by way of example, an elapsed time is multiplied by a coefficient less than 1 to correct the elapsed time. However, other examples may be used. For example, a specific value may be subtracted from an elapsed time for correction. The illustrated values are merely examples, and other values may be used. In an embodiment, furthermore, the links 241 to files that are accessed during the previous call are displayed by way of example. However, other examples may be used. For example, the links 241 to files that are accessed during the previous call and the further previous call may be displayed. In this case, after the links 241 to all the files accessed during the previous call are displayed, the links 241 to the files accessed during the further previous call may be displayed on the basis of the resulting corrected elapsed times.

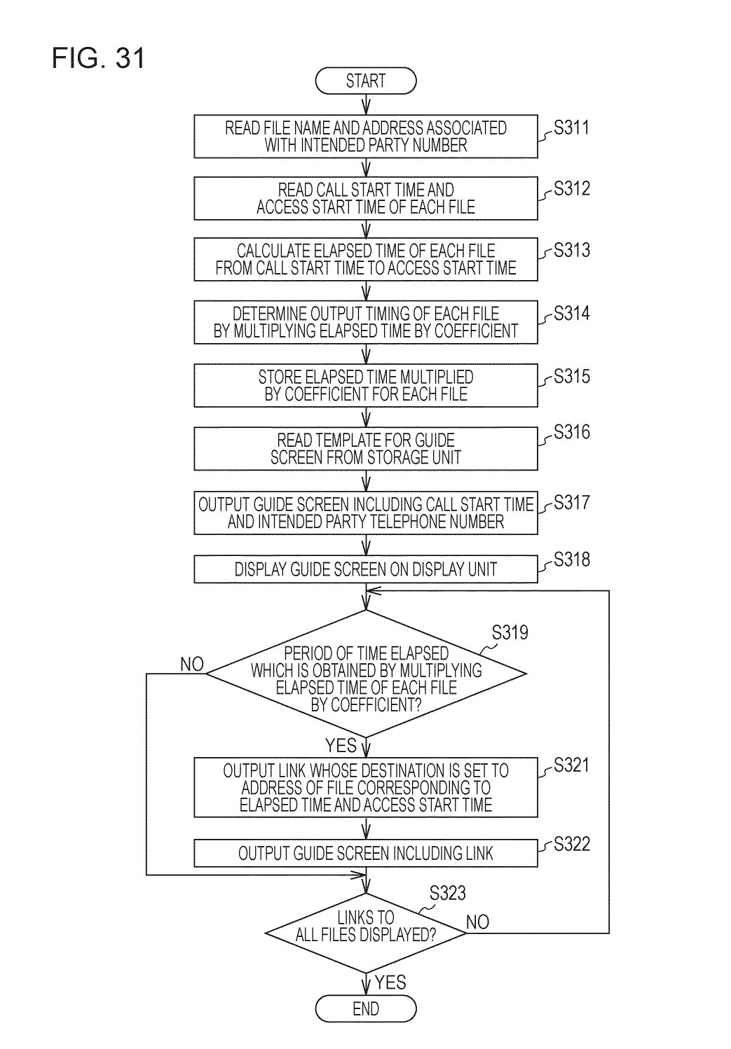

FIG. 31 illustrates a processing for displaying. As in the processing of operation S235 described in detail above, file names and addresses associated with an intended party number are read from the operation record file 251 (operation S311). The CPU 21 also reads the call start time corresponding to the files having the read file names and addresses and the access start times of the files (operation S312). The CPU 21 calculates the elapsed time from the call start time to the access start time of each of the files having the read file names and addresses (operation S313). The CPU 21 multiplies the elapsed times by the coefficients stored in advance in the storage unit 25, and determines the output timings of the files (operation S314).

The CPU 21 stores the elapsed times multiplied by the coefficients for the individual files in the storage unit 25 (operation S315). The CPU 21 reads a template for a guide screen from the storage unit 25 (operation S316). The CPU 21 outputs a guide screen including, as illustrated in FIG. 30, the call start time and the intended party number to the display unit 24 (operation S317). The CPU 21 displays the guide screen on the display unit 24 (operation S318). After the guide screen is displayed on the display unit 24, the CPU 21 determines whether or not the period of time obtained by multiplying the elapsed time for each of the files by the coefficient has elapsed (operation S319).

If it is determined that the period of time obtained by multiplying the elapsed time by the coefficient has elapsed (YES in operation S319), the CPU 21 outputs the link 241 whose destination is set to the address of the file corresponding to the elapsed time and the access start time to the display unit 24 (operation S321). The CPU 21 displays the guide screen including the link 241 on the display unit 24 (operation S322). After the processing of operation S322 or if it is determined in operation S319 that the period of time obtained by multiplying the elapsed time by the coefficient has not elapsed (NO in operation S319), the CPU 21 determines whether or not the links 241 to all the files have been displayed on the display unit 24 (operation S323).

If it is determined that the links 241 to all the files have not been displayed (NO in operation S323), the CPU 21 returns to operation S319, and repeats the above process. If it is determined that the links 241 to all the files have been displayed (YES in operation S323), the CPU 21 ends the process. Therefore, the links 241 are sequentially displayed as time passes since the display of the guide screen. An embodiment further provides fast-forward viewing in accordance with the access times of files while a call was made, thus allowing a user to understand what order and timing the files have been opened while the call was made, resulting in the realization of smoother conversations.

Since other features of one embodiment are similar to those of the other embodiments, corresponding portions are assigned the same reference numerals and detailed description thereof is thus omitted.

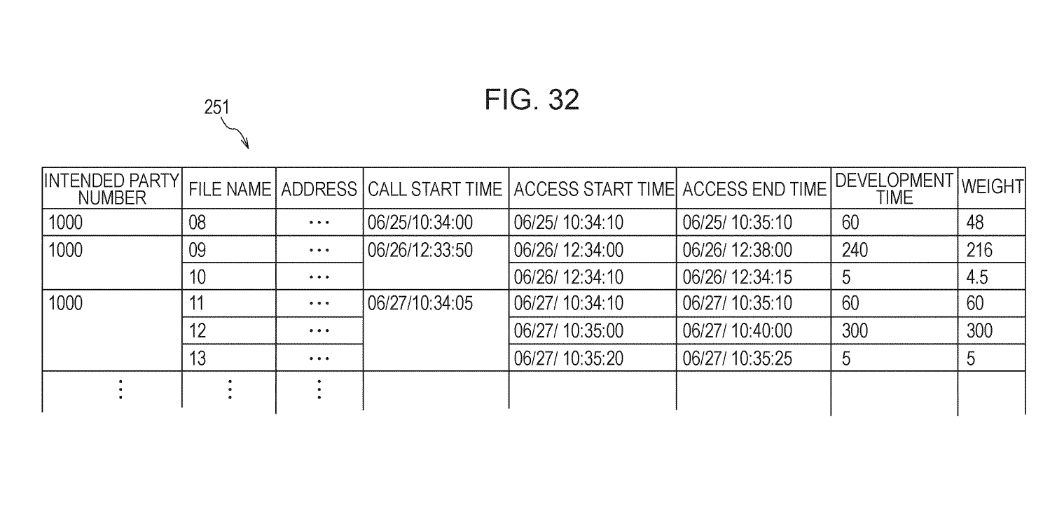

An embodiment relates to the preferential display of a file that is open for a long time. FIG. 32 illustrates a record layout of an operation record file 251 according to an embodiment. The operation record file 251 further includes a development time field and a weight field. A CPU 21 stores the period of time from the access start time to the access end time in the operation record file 251 as the development time from the opening to the closing of a file. In the example of FIG. 32, it can be understood that a file with file name “12” has the longest development time and that a file with file name “10” is closed only five seconds later.

A file having a short development time can possibly have a low level of importance. Further, as time passes, the level of importance of a file whose access start time or call start time is early can be reduced. The CPU 21 calculates the weight of each file on the basis of the development time calculated based on the access start time and the access end time and the earliness of the call start time. For example, for files whose call start time is the latest, namely, June 27, the development time is multiplied by a coefficient of 1. Then, the CPU 21 may reduce the value of the coefficient each time the call start times of the files go back one day. For example, each time the call start time goes back one day, the value of the coefficient may be reduced by ten percent. In this example, the development time of file “09” associated with the preceding day, namely, June 26, is 240 which is multiplied by a coefficient of 0.9 to yield a weight of 216. In an embodiment, by way of example, the value of the coefficient is reduced by 0.1 for each day, such as a coefficient of 0.9 for the preceding day and 0.8 for two days before the latest call start time stored in the operation record file 251. The illustrated values are merely examples, and other values may be used.

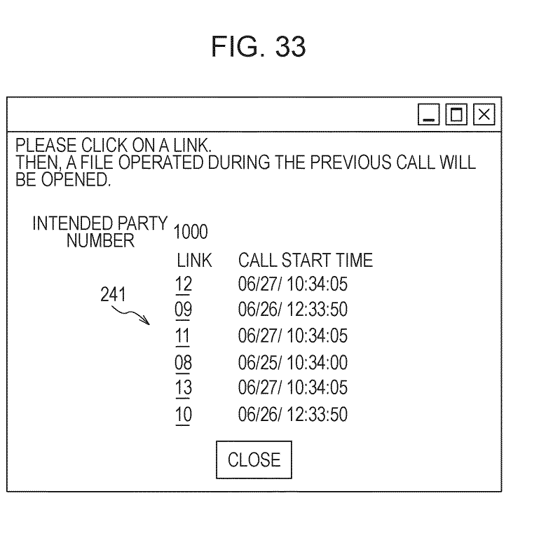

The CPU 21 calculates weights for all the files, and stores the weights in the operation record file 251. FIG. 33 illustrates a displayed image including links 241. The CPU 21 sorts the links 241 to read files in descending order from the greatest weight, and outputs the links 241 to a display unit 24 in the order of sorting. In the example of FIG. 33, the link 241 to file “12” is displayed at the top. The link 241 to file “10” whose call start time is early and development time is short, on the other hand, is displayed at the bottom. In an embodiment, a weight is calculated on the basis of the development time and the call start time, by way of example. However, other examples may be used. For example, a weight may be calculated using only one of the development time and the call start time.

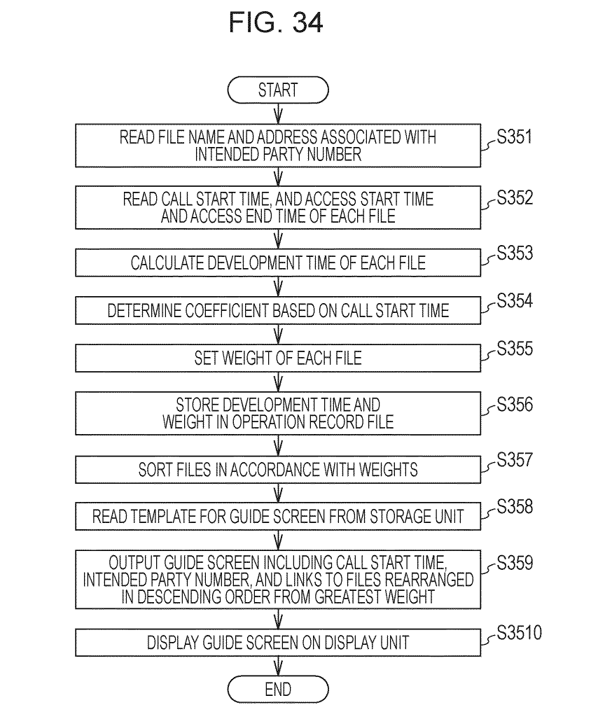

FIG. 34 illustrates a procedure for displaying according to an embodiment. As in the processing of operation S235 described in detail above, file names and addresses associated with an intended party number are read from the operation record file 251 (operation S351). The CPU 21 also reads the call start time corresponding to the files having the read file names and addresses and the access start times and access end times of the files (operation S352). The CPU 21 calculates the development time from the read access start time to access end time of each of the files (operation S353).

The CPU 21 determines a coefficient on the basis of the call start time of each of the files (operation S354). The CPU 21 calculates the elapsed day from the latest call start time among the call start times stored in the operation record file 251. The CPU 21 reads the associated coefficient from the storage unit 25 where coefficients are stored in association with elapsed days. Therefore, the coefficients assigned to the individual files can be determined. The CPU 21 multiplies the development time by the coefficient for each of the files to set (calculate) a weight (operation S355).

The CPU 21 stores the calculated development times and weights of the individual files in the operation record file 251 (operation S356). The CPU 21 sorts the files in accordance with the calculated weights (operation S357). The CPU 21 reads a template for a guide screen from the storage unit 25 (operation S358). The CPU 21 outputs a guide screen including the call start times, the intended party number, and the links 241 to the files which are rearranged in descending order from the greatest weight to the display unit 24 (operation S359). The CPU 21 displays the guide screen on the display unit 24 (operation S3510), and ends the process. Therefore, a user can access files starting from a file that can be estimated to have a high level of importance, resulting higher conversation efficiency.

Since other features of an embodiment are similar to those of the other embodiments, corresponding portions are assigned the same reference numerals and detailed description thereof is thus omitted.

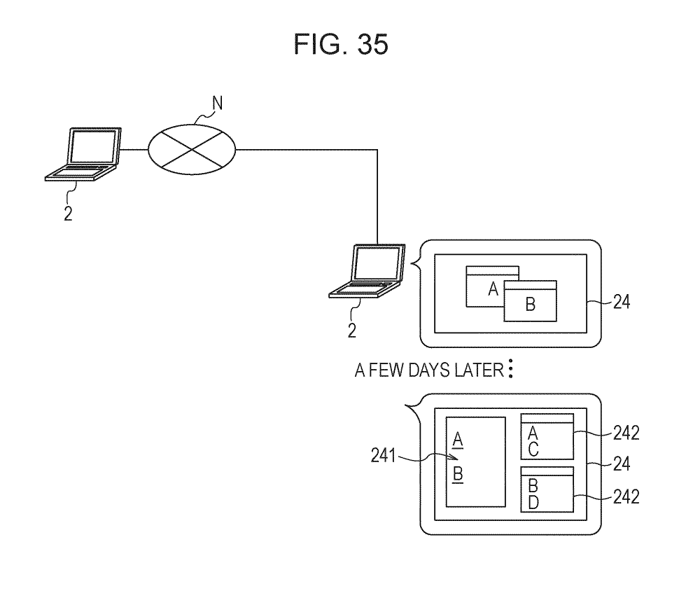

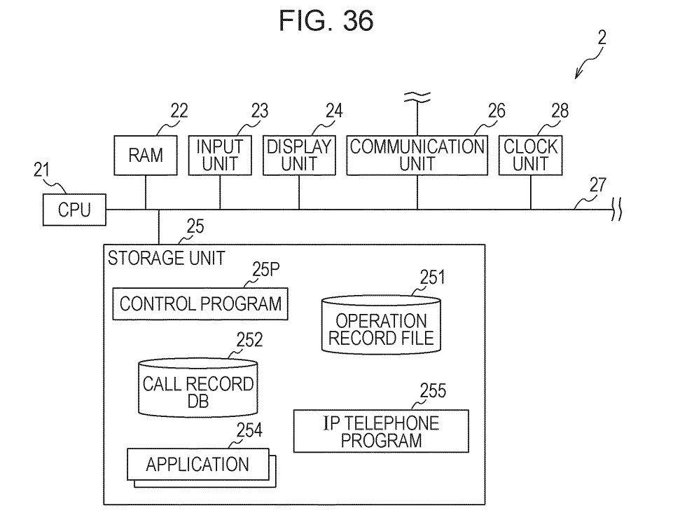

An embodiment relates to the initiation of a call from the computer 2. FIG. 35 illustrates an overview of a display system according to an embodiment. An information processing apparatus 2 according to an embodiment may be a personal computer or the like (hereinafter referred to as a “computer 2”), and makes a call with another computer 2 via a communication network N such as the Internet. FIG. 36 is a block diagram of the hardware of the computer 2. A storage unit 25 stores an IP telephone program 255 for allowing the computer 2 to make an IP telephone call, such as Skype (registered trademark).

A CPU 21 executes the IP telephone program 255 to make a call and to acquire the intended party number. The intended party number may be the nickname, ID, IP address, or the like of a user. A process for storing an operation record after the acquisition of an intended party number and a process of displaying links 241 during a call are similar to those of the above-described embodiment or the like, and will not be described herein in detail. Accordingly, the utilization of the IP telephone program 255 installed in the computer 2 allows improved business efficiency during a call with a simple configuration.

Since other features of an embodiment are similar to those of the other embodiments, corresponding portions are assigned the same reference numerals and detailed description thereof is thus omitted.

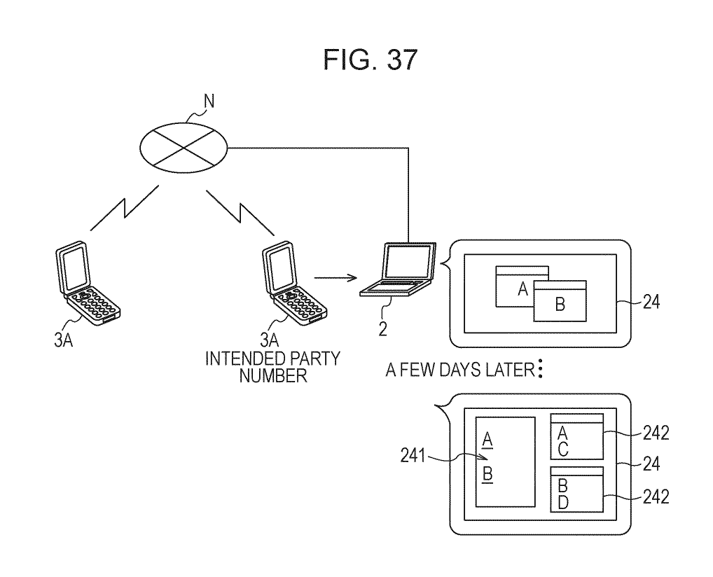

An embodiment relates to the use of a mobile terminal and the computer 2. FIG. 37 illustrates an overview of a display system according to an embodiment. The display system includes mobile terminals 3A each having a calling function based on a mobile telephone network, a wireless LAN, or the like, and a computer 2 serving as an information processing apparatus. The mobile terminals 3A are, for example, mobile telephones, personal digital assistance (PDA) devices, portable audio players, portable game devices, or the like. In the following description, the mobile terminals 3A are mobile telephones (hereinafter referred to as “mobile telephones 3A”).

One of the mobile telephones 3A, upon receiving a call from another mobile telephone 3A, the IP telephone terminal 5 described above with respect to the other embodiments, or another telephone or when making a call, outputs the intended party number to the computer 2. The computer 2 acquires the output intended party number. In an embodiment, the intended party number is, for example, a telephone number, a number uniquely assigned to each of the mobile telephones 3A, an ID of an IC card contained in each of the mobile telephones 3A, or the like.

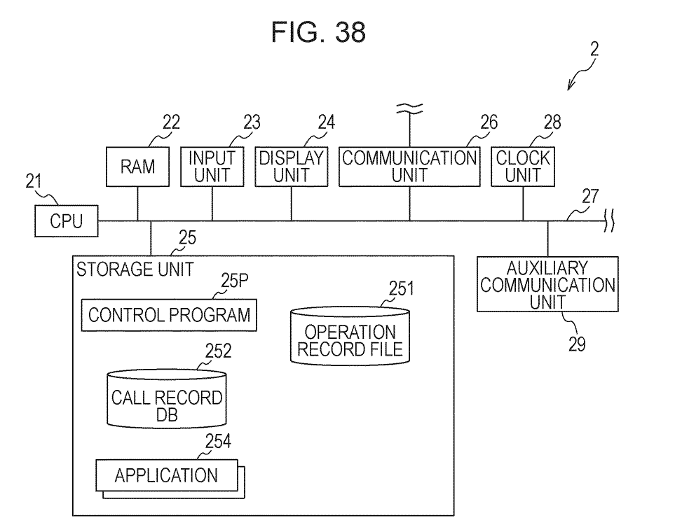

FIG. 38 is a block diagram of the hardware of the computer 2 according to an embodiment. In an embodiment, the computer 2 further includes a auxiliary communication unit 29. The auxiliary communication unit 29 is a device configured to transmit and receive information about an intended party number to and from the mobile telephones 3A, such as a device configured to transmit and receive information according to the Bluetooth (registered trademark) standard or a device configured to transmit and receive information via infrared communication. When an intended party number is transmitted from one of the mobile telephones 3A, the auxiliary communication unit 29 acquires the intended party number and outputs it to the CPU 21. As described above, the CPU 21 executes a process for storing a file operation record while the call is made and a process for displaying a link 241 while the call is made. The intended party number may also be acquired by manually inputting the intended party number by a user using the input unit 23.

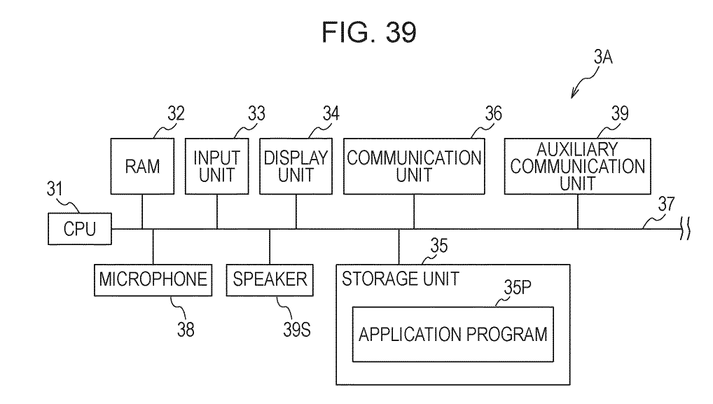

FIG. 39 is a block diagram of the hardware of each of the mobile telephones 3A. The mobile telephone 3A includes a CPU 31 serving as a control unit, a RAM 32, an input unit 33, a display unit 34, a communication unit 36, a microphone 38, a speaker 39S, an auxiliary communication unit 39, a storage unit 35, and any other suitable unit. The CPU 31 is connected to the hardware units of the mobile telephone 3A via a bus 37, and controls them. The CPU 31 also executes various software functions in accordance with a control program (not illustrated) stored in the storage unit 35.

The display unit 34 is, for example, a liquid crystal display or the like, and is configured to display an intended party number and the like. The input unit 33 includes a push button and other suitable components. The display unit 34 and the input unit 33 may be integrated into a single unit such as a touch panel. The speaker 39S amplifies a speech signal for speech data, call data, or speech input from the microphone 38, and outputs the amplified speech signal. The microphone 38 converts a speech signal input from outside into an electrical signal. After the conversion, the electrical signal is converted into digital data using an A/D converter (not illustrated), and the digital data is output to the CPU 31. The communication unit 36 includes a radio frequency (RF) transmitting/receiving unit, an antenna, and any other suitable unit, and is configured to transmit and receive various data including speech data and text data. The auxiliary communication unit 39 is a device configured to transmit an intended party number to the auxiliary communication unit 29 of the computer 2. Like the auxiliary communication unit 29, the auxiliary communication unit 39 may be a device configured to transmit and receive information according to the Bluetooth (registered trademark) standard, a device configured to transmit and receive information via infrared communication, or the like.

The storage unit 35 stores an application program 35P and the like. The CPU 31 stores the application program 35P, which is downloaded from a server computer (not illustrated) via the communication unit 36, in the storage unit 35. When receiving or making a call, the CPU 31 activates the application program 35P, and outputs the intended party number to the computer 2 via the auxiliary communication unit 39. Therefore, users or the like who carry the mobile telephones 3A and the computer 2 for use can view information about a file associated with a previous call, resulting in improved work efficiency.

Since other features of an embodiment are similar to those of the other embodiments, corresponding portions are assigned the same reference numerals and detailed description thereof is thus omitted.

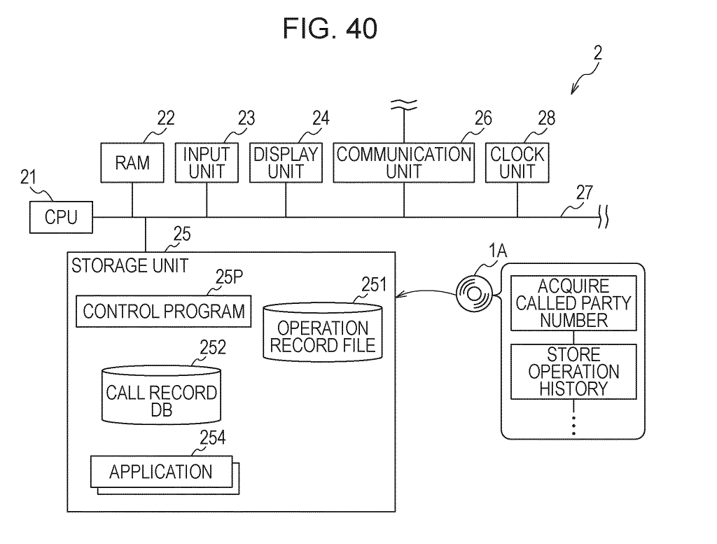

FIG. 40 is a block diagram of hardware of a computer 2 according to an embodiment. In an embodiment, a program for activating the computer 2 is stored in a storage unit 25 by reading a portable recording medium 1A such as a compact disk read only memory (CD-ROM) using a reader (not illustrated). In the foregoing embodiments, a program for activating the computer 2 may also be stored in the storage unit 25 by reading a portable recording medium such as a CD-ROM using a reader. The program can also be downloaded from a server computer (not illustrated) that is connected via a communication unit 26. The details will now be described.

The computer 2 illustrated in FIG. 40 downloads a program for acquiring an intended party number, storing an operation record, and performing other processes from the portable recording medium 1A or another server computer (not illustrated) via the communication unit 26. This program is installed as a control program 25P in the storage unit 25, and is loaded into a RAM 22 and executed. Therefore, the computer 2 implements the functions as described above. It is to be understood that the above program may also be installed into the storage unit 15 of the terminal server 1.

Since other features of an embodiment are similar to those of the other embodiments, corresponding portions are assigned the same reference numerals and detailed description thereof is thus omitted.

According to an aspect, information about a file operated while a previous call is made is output during a current call. Therefore, advantageously, for example, smooth and efficient communications can be achieved. A computer-implemented method of processing information is provided which includes identifying a file based on usage of the file in association with a previous telephone and displaying an identifier of the file with an access path to the file when determining that the previous telephone call has identifying information that matches a caller of a current telephone call.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A computer-readable storage medium storing a program for causing a computer to output information, the program causing the computer to execute an operation comprising:
acquiring identification information for identifying an intended party;
storing, when the identification information is acquired in the acquiring, a file operation record indicating a file operated during a call in a storage unit so that the file operation record is associated with the identification information; and
outputting, in a case of determining that identification information that matches identification information stored in the storage unit is acquired in the acquiring, information about a file stored in the storage unit in association with the acquired identification information.

2. The computer-readable storage medium according to claim 1, wherein the outputting includes outputting, in a case of determining that identification information that matches identification information stored in the storage unit is acquired in the acquiring, a link for accessing a file stored in the storage unit in association with the acquired identification information.

3. The computer-readable storage medium according to claim 1, comprising:
outputting a folder including the file.

4. The computer-readable storage medium according to claim 1, wherein the storing includes storing, when identification information is acquired in the acquiring, a file operation record including a call time, an address of a file accessed during a call, and an access time in the storage unit so that the file operation record is associated with the identification information.

5. The computer-readable storage medium according to claim 1, wherein the storing includes storing, when identification information is acquired in the acquiring, a file operation record including a call time, an address of a file accessed during a call, an access start time, and an access end time in the storage unit so that the file operation record is associated with the identification information.

6. The computer-readable storage medium according to claim 5, wherein the outputting includes outputting, in a case of determining that identification information that matches identification information stored in the storage unit is acquired in the acquiring, links that are based on addresses of a plurality of files in accordance with access start times of the files, the plurality of files being stored in the storage unit in association with the acquired identification information.

7. The computer-readable storage medium according to claim 5, comprising:
determining, based on access start times of a plurality of files stored in the storage unit, output timings of the files, and
wherein the outputting includes outputting, in a case of determining that identification information that matches identification information stored in the storage unit is acquired in the acquiring, links that are based on addresses of the plurality of files in accordance with the output timings of the files determined in the determining, the plurality of files being stored in the storage unit in association with the acquired identification information.

8. The computer-readable storage medium according to claim 4, wherein the outputting includes outputting, when determining that identification information that matches identification information stored in the storage unit is acquired in the acquiring, a call time corresponding to the acquired identification information, a link for accessing a file stored in the storage unit in association with the acquired identification information, and an access time of the file.

9. The computer-readable storage medium according to claim 5, comprising:
setting a weight for the file in accordance with the access start time and the access end time, and
wherein the outputting includes outputting, in a case of determining that identification information that matches identification information stored in the storage unit is acquired in the acquiring, links that are based on addresses of a plurality of files in accordance with weights of the files set in the setting, the plurality of files being stored in the storage unit in association with the acquired identification information.

10. The computer-readable storage medium according to claim 9, wherein the setting includes setting a weight for each file in accordance with an access start time, an access end time, and a call time.

11. The computer-readable storage medium according to claim 9, wherein the outputting includes outputting, in a case of determining that identification information that matches identification information stored in the storage unit is acquired in the acquiring, information about a file stored in the storage unit in association with the acquired identification information to an information processing apparatus connected via a communication network.

12. The computer-readable storage medium according to claim 1, wherein the outputting includes outputting, in a case of determining that identification information that matches identification information stored in the storage unit is acquired in the acquiring, information about a file stored in the storage unit in association with the acquired identification information to a display unit.

13. An information processing apparatus which outputs information, the information processing apparatus comprising:
an acquisition unit that acquires identification information for identifying an intended party;
a storage unit that stores, when the identification information is acquired by the acquisition unit, a file operation record indicating a file operated during a call in a storage unit so that the file operation record is associated with the identification information; and
an output unit that outputs, in a case of determining that identification information that matches identification information stored in the storage unit is acquired by the acquisition unit, information about the file stored in the storage unit in association with the acquired identification information.

14. An output method for outputting information using an information processing apparatus including a control unit, the output method comprising:
acquiring, by the control unit, identification information for identifying an intended party;
storing, by the control unit, when the identification information is acquired in the acquiring, a file operation record indicating a file operated during a call in a storage unit so that the file operation record is associated with the acquired identification information; and
outputting, by the control unit, in a case of determining that identification information that matches identification information stored in the storage unit is acquired in the acquiring, information about a file stored in the storage unit in association with the acquired identification information.

15. A computer-implemented method of processing information, comprising:
identifying a file based on usage of the file in association with a previous telephone call; and
displaying an identifier of the file with an access path to the file when determining that the previous telephone call has identifying information that matches a caller of a current telephone call.
